(19) United States
(12) Patent Application Publication
(10) Pub. No.: US 2010/0001482 A1
(43) Pub. Date: Jan. 7, 2010

(54) CARRIER DEVICE

(76) Inventor: Robin More, Essex (GB)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/514,666

(22) PCT Filed: Nov. 14, 2007
(86) PCT No.: PCT/GB07/04345

§ 371 Date: May 13, 2009

(30) Foreign Application Priority Data
Nov. 14, 2006 (GB) 0622686.4
Sep. 7, 2007 (GB) 0717494.9
Sep. 27, 2007 (GB) 0718964.0

(51) Int. Cl. B62B 1/26; B66C 1/00

(52) U.S. Cl. 280/47.131; 294/113

(57) ABSTRACT

A static or portable carrier device for holding sensitive equipment, such as pressurised fluid containers, comprises a first jaw (1) with a cradle (2) for holding the equipment (5), and a second jaw (3), movably mounted on the first jaw (1) and configured to locate over and at least partly span the equipment (5) and urge it into the cradle (2). The second jaw (3) is pivoted to rotate on the first jaw (1), and may comprise a cover (4) which spans the cradle for hold the equipment. The jaws define a partially open-sided enclosure, in which the equipment, such as a gas cylinder, e.g. for industrial or medical gases such as oxygen, a fire extinguisher, or other, e.g. resuscitation equipment, is protected from damage during storage, transport and/or manoeuvring of the laden device and/or in hazardous situations, such as accidents, but is readily removable when necessary.

This invention relates to a carrier device, and the structure of such a carrier device, that is adapted to locate and hold equipment of widely varying shape and size easily, safely and securely without damage or exposure to damage, whilst ensuring that the equipment is readily removable when necessary.

The device of the present invention may be used as a static and/or movable (including portable) storage and/or transport device.

In one aspect, the device may be used to hold equipment that is not sensitive, fragile and/or potentially dangerous, so that the device does not particularly need to protect the equipment from damage during use, but needs to hold it securely in position, whilst ensuring that the equipment is not damaged and is readily releasable and removable when necessary.

Devices to secure items together temporarily, such as components of a temporary framework, chassis, lattice, scaffold, board, divider, panel, partition, screen or wall, e.g. for a covered entrance, exhibition area, gazebo, marquee, pavilion, portico, tent or other temporary accommodation, building, construction or structure, or a spectator area or other temporary space, or temporary fencing or scaffolding, are well known. Devices to secure other items together temporarily, such fixing temporary advertisements, billboards, directions, display boards, hoardings, notices, signs or signboards to a framework, chassis, lattice, scaffold, trellis, bulkhead, divider, panel, partition, screen or wall are also well known.

All these generally have failed to properly address the problem of easily and safely securing the items in position, whilst ensuring that the items are not damaged and is readily releasable and removable when necessary. Thus fastening means, such as bolts, nails, pins, screws and staples potentially damage the items that they fasten. These and other fastening means, such as bolts, nails, pins, screws and staples potentially damage the items that they fasten.

These and other fastening means, such as buckles, clamps, clips and shackles, as used conventionally on scaffolding, whilst holding them securely in position, do not ensure that the items are readily releasable and removable.

Additionally, they cannot be used in general with items of widely varying shape and size, or indeed that are not of a complementary shape to the device.

In order to overcome these problems, it is an object of the present invention to provide a carrier device, in which equipment is securely located and held by the device, but is readily removable when necessary.

Another object of the present invention is to provide a device for holding equipment which is irregular and/or of a wide range of shapes and sizes, and does not damage the equipment.

In another aspect, the device may be used to hold sensitive, fragile and/or potentially dangerous equipment, e.g. a pressurised fluid container, such as a gas cylinder, e.g. for industrial or medical gases such as oxygen; a fire extinguisher; or other such equipment, e.g. ordnance, such as a bomb, shell missile or torpedo. The device may also be used to hold sensitive and fragile equipment, e.g. a refreshments container, e.g. for food or drink, such as a glass vessel, e.g. a bottle, jar or pot.

It may also be used to carry resuscitation equipment, as well as associated items of apparatus which may need to be carried by medical and/or emergency and/or accident personnel for use in an emergency and/or accident situation. This invention therefore also concerns a mobile resuscitation system which includes such a device, which can be used in the field, mainly to keep patients alive until proper medical, emergency and/or accident transport arrangements can be made.

The carrier device may also be adapted for fitting in static locations, such as an emergency and/or accident or first aid station in an industrial plant or air, land or sea transportation, from which the carrier device may need to be moved to an emergency and/or accident site; to be a portable or towable or pushable device for use when away from a permanent installation; for fitting to a variety of mobile structures such as emergency trolleys and stretchers, beds and chairs and emergency and/or accident service or military vehicles; or for industrial, commercial or military transportation of potentially dangerous equipment.

Devices to store and/or transport pressurised fluid containers in industrial and commercial premises and hospitals are well known.

They generally have failed to properly address the problem of easily and safely preventing exposure of delicate parts to potential damage in anything other than a very controlled environment, such as a hospital. Not only that, but if needed to be portable or towable or pushable, they too heavy for safe or easy movement by an individual.

Simple static or portable cylinder storage and transport devices are known, but are designed to be of a shape and size that is complementary to, if not approximately the same as, that of a given cylinder.

Thus, they cannot be used with another cylinder that is larger or smaller by too great a degree, and still less with any apparatus that is not apparatus of constant cylindrical cross section and/or irregular or otherwise not of a complementary shape to the device.

Although such devices are easy to construct, they also do not provide a secure space for the pressurised fluid containers, in which the equipment is protected from damage during storage, in accident situations, or in emergencies where it may be required to manoeuvre a portable device into difficult confined spaces in rough conditions of use by emergency and/or accident personnel, where it is essential to protect the equipment from damage during transport and use in a range of trying environments.

Inside and outside industrial and commercial premises and hospitals, the pressurised fluid containers are often held in place by slide-over, hinged or pivoted arms or plastics straps, configured and adapted to be latched or locked to hold them in position. Such latches or locks in a closure position are not usually readily releasable.

Plastic straps age, leading to degradation of the physical strength thereof, and the straps can fast become brittle and break, especially if the device houses, in use, a pressurised fluid container, such as a gas cylinder, which contains an oxidant, such as oxygen, leading to an environment with increased oxygen concentration

In order to overcome these problems, it is an object of the present invention to provide a carrier device, in which the equipment is protected from damage during storage, and in particular in accident situations, emergencies, in rough conditions of use by emergency and/or accident personnel and/or in a range of trying environments.

It is another object of the present invention to provide a device where sensitive and/or fragile equipment, such as pressurised fluid containers, is securely located by the carrier device, in particular during transport and/or manoeuvring of the laden device, but is readily removable when necessary.

Another object of the present invention is to provide a device for holding sensitive and/or fragile equipment, such as pressurised fluid containers, e.g. oxygen cylinders, with minimal risk of degradation of the physical strength and breakage of the device in use.

Another object of the present invention is to provide a device that is lightweight and movable or portable.

An object of the present invention is to provide a device for holding sensitive and/or fragile equipment, such as pressurised fluid containers, that is easy to construct, capable of holding a wide range of sensitive and/or fragile equipment, such as pressurised fluid containers, which is irregular and/or of a wide range of shapes and sizes, whether it is irregular or regular, e.g. of constant cylindrical cross section.

Therefore, according to the present invention there is provided a static or portable device for holding equipment, characterised by

a first jaw for holding the equipment, and
a second jaw, movable with respect to the first jaw and configured to locate over and at least partly span the equipment and urge it into the first jaw.

The first jaw in the device may have a cradle, configured to receive the equipment. The first jaw and the cradle for holding the equipment may be separate integers, or the first jaw may be integral with the cradle.

The device may be adapted for use in a variety of situations, but is one use is for sensitive and/or fragile equipment such as pressurised fluid containers for medical and/or emergency and/or accident purposes, and/or for the provision of a secure but easily accessible space for pressurised fluid containers, in which the equipment is protected from damage during storage, transport and/or manoeuvring of the laden device and/or in hazardous situations, such as accidents, but is readily removable when necessary. Both features could be literally the difference between life and death.

The first jaw and the second jaw, which is movable with respect to the first jaw, may be separate integers, or the first jaw may be integral with the second jaw.

In the first instance, the first jaw and second jaw may be translationally and/or rotationally movable with respect to the each other.

In the second, the first jaw and the second jaw form parts of the same integer, and are rotationally movable about each other. For example, the first jaw and the second jaw may form parts of one or more separate annular members, each capable of surrounding the item of equipment), and mounted so as to be rotatable in a plane generally at right angles to the plane of the annular member.

It will be seen that rotation about the pivot(s) will cause the second jaw to move with respect to the first jaw and, once engaged with the equipment, urges it into the first jaw and/or any cradle for holding the equipment.

Surprisingly, we have now found that the present device may be so configured and adapted that simply urging the equipment between the jaws will cause the jaws to close to hold and support the equipment without the need for separate closure mechanisms, such as actuating cams and/or levers, as used hitherto.

When the carrier device is used in upright fashion, i.e. with the first jaw holding the equipment upright, the weight of the equipment itself causes the jaws to close to hold the equipment under gravity alone.

Accordingly, a preferred embodiment of the device of the present invention is characterised by

a first jaw for holding the equipment,
a second jaw, movable with respect to the first jaw and configured to locate over and at least partly span the equipment and urge it into the first jaw, and
at least one locating means on and projecting inwardly from the second jaw, which locates the equipment between the jaws,
such that in use of the device, when the equipment presses on the locating means it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws. It will be seen that the weight of the equipment on the locating means on and projecting inwardly from the second jaw assembly will cause the second jaw to close with respect to the first jaw under gravity and urges the equipment into the first jaw and/or any cradle to hold the equipment.

In one form of the device of the present invention there is provided a static or portable device for holding equipment, characterised by

a mounting, and
a jaw assembly rotatably mounted on the mounting and comprising a first jaw optionally with a cradle for holding the equipment, attached to or integral with a second jaw,
the jaw assembly being configured to at least partly span the equipment and such that rotation of the assembly gives the first and second jaws mutual rotational motion and urges the equipment into the first jaw or any cradle.

In its simplest form the jaw assembly may comprise a single C- or U-shaped member, or an annulus, or a square or oblong equivalent of any of these.

In these, one leg of the C or U or one side of the annulus (or the square or oblong equivalent of any of these) is the first jaw and the other opposing leg or side is the second jaw.

This member may have a single pivot tangentially aligned to one leg of the C or U or to the annulus (or similarly aligned to a square or oblong equivalent of any of these), or diametrically aligned at a position at or near to the centre of the C or U or at one side of the annulus (or similarly aligned to a square or oblong equivalent of any of these).

Alternatively, it may be provided with two diametrically aligned pivots, on opposite sides of the annulus (or similarly aligned to a square or oblong equivalent thereof).

It will be seen that rotation about the pivot(s) will cause the second jaw to move with respect to the first jaw and, once engaged with the equipment, urges it into the first jaw and/or any cradle for holding the equipment.

Alternatively the jaw assembly may be a series of separate integers, or a series of connected members. Thus, the jaw assembly may be a series of connected members, each being as described for the simplest jaw assembly above, often two such members, one towards the top end of the carrier structure, and the other towards the base. Most preferably, the members have the same dimensions and configurations.

To enable the desired movement within the device, the members may be connected, e.g. by one or more longitudinal connectors, such as rigid bars, poles, rails, or rods, running generally at right angles to the members, and each being pivotally mounted on the members, often between only a pair of members respectively towards or at the top end and bottom end of the device. Where there are several connectors and/or members, they effectively form a cage structure around the equipment that is slid between and held by the first and second jaws and any cradle in use, when the jaw assembly of the device is rotated to a closure position to hold the equipment.

The jaw assembly may be pivotally mounted on pivotal mounting means, e.g. brackets or trunnions on the mounting.

The mounting is generally mounted directly or indirectly (e.g. mounted on a board or panel that is directly mounted) on an external structure, i.e. as appropriate

an upright integer, such as a bulkhead, divider, panel, partition, riser, screen or wall;
a generally horizontal integer, such as a bottom panel, base plate, floor or stand, or flooring; or
the underside of a generally horizontal integer, such as a ceiling, cover, lid, roof or top panel.

The jaw assembly of the device is generally provided with at least one locating means, e.g. a foot or base projecting inwardly of the bottom end of the jaw assembly, or a strap, lashing or tie to the other jaw.

This locates one end of the equipment longitudinally between the jaws. When the carrier device is used in upright fashion such means are essential to support the bottom end of the equipment on the jaw assembly.

In this mode of use of this embodiment of the device of the present invention described above, where the jaw assembly comprises at least two members, such a foot or base projecting inwardly of the jaw assembly is usually on the lowermost jaw assembly member. The foot or base projecting inwardly of the jaw assembly may be extended over any proportion of the lowermost member.

The member and the foot or base may together form a bowl, cup or saucer configured to receive the lowermost part of the equipment, such as a pressurised fluid container, when the members drop down under gravity.

The device may be latchable to retain the equipment once the jaws close on it securely.

Accordingly, a preferred embodiment of the device of the present invention is characterised by

a mounting, and
a jaw assembly rotatably mounted on the mounting and comprising a first jaw optionally with a cradle for holding the equipment, attached to or integral with a second jaw, and
at least one locating means on and projecting inwardly from the second jaw, which locates the equipment between the jaws,
the jaw assembly being configured to at least partly span the equipment and such that rotation of the assembly gives the first and second jaws mutual rotational motion and urges the equipment into the first jaw or any cradle, and the device being configured such that in use of the device of the present invention described above, when the equipment presses on the locating means it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws. It will be seen that the weight of the equipment on the locating means on and projecting inwardly from the second jaw assembly will cause the second jaw to close with respect to the first jaw under gravity and urges the equipment into the first jaw and/or any cradle to hold the equipment.

In another form of the present invention there is provided a static or portable device for holding equipment, characterised by

a first jaw optionally with a cradle for holding the equipment, and
a second jaw, movably mounted on the first jaw and configured to locate over and at least partly span the equipment and urge it into the first jaw and any cradle.

The device may be adapted for use in a variety of situations, but is primarily intended for sensitive and/or fragile equipment, such as pressurised fluid containers, for medical and/or emergency and/or accident purposes, and/or for the provision of a secure but easily accessible space for pressurised fluid containers. In this, the equipment is protected from damage during storage, transport and/or manoeuvring of the laden device and/or in hazardous situations, such as accidents, but is readily removable when necessary. Both features could be literally the difference between life and death.

In such devices, the first jaw and any component cradle for the equipment are often elongate in the same direction, and the two ends of these integers are respectively described herein as the top end and bottom end of the relevant integer, corresponding to the top end and bottom end of the device.

Each of the first jaw and the second jaw, which is movable with respect to the first jaw, may take a variety of forms dependent on the particular features of the device.

Thus it may be a single essentially continuous integer, such as a plate or laminate; a series of separate integers; or a series of connected members, such as bars, rods, rails or rungs, which form a framework, chassis or scaffold.

As for the jaws, any cradle for receiving the equipment may be a single essentially continuous integer, such as a plate or laminate, which may take a variety of forms dependent on the particular features of the device container; a series of separate integers, or a series of connected rigid members, such as bars, rods, rails or rungs, which form a framework, chassis or scaffold.

The device may be used in upright, inverted or laid-down fashion, especially at an emergency and/or accident site, so the terms ‘top end’ and ‘bottom end’ of the relevant integer or device are therefore in no way limiting.

Preferably, the second jaw is pivoted to rotate on the first jaw. In its simplest form the second jaw may comprise a single arm, which is pivoted to rotate about a position on a longer side of the first jaw or any cradle and extends to at least partly transversely span the cradle for holding the equipment. This single arm may have a single pivot, and may e.g. be L- or C-shaped.

Alternatively, it may be provided with two pivots, on opposite sides of the first jaw or any cradle and at opposite ends of e.g. a C-, U-shaped arm, or a square or oblong equivalent thereof.

As noted above, in the carrier device, each of the first jaw, the optional cradle for holding the equipment, and the second jaw may be a series of separate integers, or

a series of connected rigid members, such as bars, rods, rails or rungs, which form a framework, chassis or scaffold.

Thus, the second jaw may be a series of connected members, such as connected arms, often two arms, one towards the top end of the carrier structure, and the other towards the base.

To enable the desired movement within the device, the arms may be connected, e.g. by one or more longitudinal connectors, such as rigid bars, poles, rails, or rods, running generally at right angles to the transverse arms which form the second jaw. Each connector is pivotally mounted on the arms, often between only a pair of arms, respectively towards or at the top end and bottom end of the device.

Where there are several connectors and/or arms, they effectively form a cage structure around the equipment that is slid between and held by the first and second jaws and any cradle in use, when the jaws of the device are rotated to a closure position to hold the equipment.

Most preferably, the arms that are pivoted on the two jaws of the device according to the present invention are characterised by having the same dimensions and configurations, so that rotation gives the first and second jaws mutual parallel motion.

In use, the second jaw spans the equipment, such as a pressurised fluid container, and urges it into the first jaw or any cradle.

A preferred embodiment of the device of the present invention is characterised by

a first jaw optionally with a cradle for holding the equipment,
a second jaw, movably mounted on the first jaw and configured to locate over and at least partly span the equipment and urge it into the first jaw and any cradle; and
at least one locating means on and projecting inwardly from the second jaw, which locates the equipment between the jaws,
such that in use of the device of the present invention described above, when the equipment presses on the locating means it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws.

It will be seen that the weight of the equipment on the locating means on and projecting inwardly from the second jaw assembly will cause the second jaw to close with respect to the first jaw under gravity and urges the equipment into the first jaw and/or any cradle to hold the equipment.

To hold the equipment, the second jaw in a device may have a member pivoted on one or more arms and extending to at least partly transversely span the first jaw or any cradle for holding the equipment.

Often, a pair of such arms is pivoted to rotate about positions on opposite longer sides of the first jaw or any cradle and on opposite longer sides of the second jaw. More often, two such pairs are pivoted to rotate about positions on opposite longer sides of the first jaw or any cradle. Often, one such pair is mounted towards the top end of the carrier device, and the other is mounted towards the bottom end of the carrier device.

The device may be provided with three or more such pairs, mounted between the top end and the bottom end of the carrier device.

In such devices, increased protection of the device contents, such as sensitive and/or fragile equipment, such as pressurised fluid containers, is desirable during storage, transport and/or manoeuvring of the laden device and/or in hazardous situations, such as accidents.

Accordingly, a preferred embodiment of the present invention is characterised by a second jaw which comprises a movable cover which is pivoted to rotate on at least two pairs of arms that are pivoted on the first jaw and spans the first jaw or any cradle for holding the equipment.

The second jaw and the cover for spanning the equipment may be different integers, or the second jaw may be integral with the cover.

To assist the protection afforded by the movable cover, it is preferred that one pair of only two pairs of arms is mounted towards the top end of the carrier device, and the other is mounted towards the bottom end of the carrier device.

In such devices, the first jaw and any component cradle for the equipment and the second jaw and any component cover may be elongate in the same direction, and often all of these integers are roughly co-extensive.

To assist the holding of equipment of regular, e.g. constant cylindrical, cross section such as pressurised fluid containers, it is preferred that the two pairs of arms that are pivoted on the two jaws of the device according to the present invention are characterised by having the same lengths between pivots, so that rotation gives the first and second jaws mutual parallel motion.

In use, the second jaw spans the equipment, such as a pressurised fluid container, and urges it into the first jaw or any cradle. This may be achieved in a variety of ways, depending to some extent on the way in which, and the purposes for which, the device is used.

When the carrier device is unladen, each arm is in its rest position, rotated to lie in close proximity to the first jaw of the device. The arms can be rotated up to a loading position, usually roughly perpendicular to the elongate first jaw. The equipment to be held, such as a pressurised fluid container, is then slid between the jaws of the device, and the arms are allowed to return to the rest position, so that the jaws hold the equipment, and the second jaw, pivoted to rotate on the first urges it into the first jaw or any cradle.

As noted above, the carrier device has a first jaw with an optional cradle for holding the equipment, and a second jaw, movably mounted on the first jaw and configured to locate over and at least partly span the equipment and urge it into any cradle.

The first jaw and any cradle for holding the equipment may be different integers, or the first jaw may be integral with any cradle.

Any cradle may have any shape and size that is compatible with the holding function of the carrier device, and preferably with its protective design and/or for the provision of a secure but easily accessible space for pressurised fluid containers.

Thus, its shape and size may be complementary to, if not approximately the same as, that of a given cylinder, i.e. any cradle may be of constant part-cylindrical cross section and/or otherwise of a complementary shape to the equipment. However, the device cannot then be used with another cylinder that is larger or smaller by too great a degree, and still less with any equipment that is not apparatus of constant cylindrical cross section and/or irregular or otherwise not of a complementary shape to the device.

Preferably, any cradle for holding the equipment is so configured as to be able to locate and cradle a wide variety of such equipment. In a device that is more preferred, the cradle and the movable cover, which may be provided with at least one, or even two or three, projections, each cooperate to provide multiple point contact to the equipment.

The versatility of the device in holding equipment that is not apparatus of constant cylindrical cross section and/or irregular or otherwise not of a complementary shape to the device, or a cylinder that is larger or smaller, is enhanced by the device of the present invention provides three-point contact with the equipment.

In a device that is more preferred, the cradle provides two-point contact, and a single projection on the movable cover provides the third point of contact with the equipment.

Preferably, the cradle and the movable cover are elongate in the same direction, the cradle is formed in the first jaw by a shallow V-channel, and the cover is defined by an integral shallow-V projection, in use cooperating with the cradle to hold an item of equipment. Alternatively, the cover provides two-point contact, and the cradle provides the third point of contact with the equipment.

The device may be adapted for use in a variety of positions, in all of which, one jaw, often but not necessarily the first jaw, with the cradle for holding the equipment, may be mounted on a fixed surface, often with the mounted jaw running generally along the mounting surface.

The carrier device may be used in upright, inverted or lateral laid-down or suspended fashion, with a static jaw of the device

when the latter is in upright or inverted fashion (top end or bottom end uppermost) being on or formed by an upright integer, such as a bulkhead, divider, panel, partition, riser, screen or wall;
when in lateral laid-down fashion, being on or formed by a generally horizontal integer, such as a bottom panel, base plate, floor or stand, or flooring; and
when in lateral suspended fashion, being on or formed by the underside of a generally horizontal integer, such as a ceiling, cover, lid, roof or top panel.

Accordingly, an embodiment of the present invention is a carrier device, characterised in that at least a part of the device is mounted on a fixed upright integer, such as a bulkhead, divider, panel, partition, riser, screen or wall, by its first jaw which runs generally along the mounting surface.

Another embodiment of the present invention is a carrier device, characterised in that at least a part of the device is mounted suspended from a generally horizontal integer, such as a ceiling or lid, by its first jaw which runs generally along the mounting surface.

When the carrier device is used in upright or inverted fashion, the arms may rotate to their rest position, and the movable jaw of the device urges the equipment into the cradle under gravity, usually less so when the carrier device is used in lateral laid-down fashion. When the carrier device is used in lateral suspended fashion, with the mounted (“static”) jaw of the device uppermost, gravity will urge the cradle and the second jaw apart.

The action of gravity may be sufficient to hold the equipment in place when the carrier device is used in upright or inverted fashion, although this may not be the case if the carrier device is to be used in a range of trying environments. This may include dragging over a rough surface or difficult terrain and manoeuvring the device into difficult confined spaces. In such cases, and in the other modes of using the device, the jaws may be urged together by other means, such as spring bias.

Alternatively (or additionally) the jaw of the device may be pushed together, and then fastened, e.g. latched or locked to hold them in a position to hold the equipment in place.

Accordingly, an embodiment of the present invention is a carrier device, characterised in that it is mounted on the underside of a generally horizontal integer, such as a ceiling, cover, lid, roof or top panel, by its first jaw which runs generally along the mounting surface, and the jaws are urged together by resilient means, such as spring bias, or the device has at least one fastener, e.g. a latch or lock, such that the jaws may be pushed together, and then fastened.

Another embodiment of the present invention is a carrier device, characterised in that at least a part of the device is mounted in lateral laid-down fashion, being on a generally horizontal integer, such as a bottom panel, base plate, floor or stand, or flooring; by its first jaw which runs generally along the mounting surface, and the jaws are urged together by resilient means, such as spring bias, or the device has at least one fastener, e.g. a latch or lock, such that the jaws may be pushed together, and then fastened.

One or both jaws, usually the movable jaw, of the device is/are usually provided with at least one locating means, e.g. a foot or base projecting inwardly of the bottom end of the jaw(s) of the device, or a strap, lashing or tie to the other jaw, to locate one end of the equipment longitudinally between the jaws. When the carrier device is used in upright fashion such means are essential to support the bottom end of the equipment on the relevant jaw(s).

Accordingly, a preferred embodiment of the present invention is characterised by a second jaw which comprises a movable cover which is pivoted to rotate on at least two pairs of arms that are pivoted on the first jaw and spans the first jaw or any cradle for holding the equipment, and

at least one locating means on and projecting inwardly from the second jaw, which locates the equipment between the jaws,
such that in use of the device of the present invention described above, when the equipment presses on the locating means it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws.

It will be seen that the weight of the equipment on the locating means on and projecting inwardly from the second jaw assembly will cause the second jaw to close with respect to the first jaw under gravity and urges the equipment into the first jaw and/or any cradle to hold the equipment.

As noted above, the first jaw and any cradle for holding the equipment may be different integers, or the first jaw may be integral with any cradle.

The second jaw and the cover for spanning the equipment may be different integers, or the second jaw may be integral with the cover.

To assist the protection afforded by the movable cover, it is preferred that one pair of only two pairs of arms is mounted towards the top end of the carrier device, and the other is mounted towards the bottom end of the carrier device.

In one form of this embodiment of the device of the present invention described above, the second jaw is pivotally mounted directly or indirectly (e.g. mounted on a board or panel that is directly mounted) on an external structure, i.e. as appropriate

an upright integer, such as a bulkhead, divider, panel, partition, riser, screen or wall;
a generally horizontal integer, such as a bottom panel, base plate, floor or stand, or flooring; or
the underside of a generally horizontal integer, such as a ceiling, cover, lid, roof or top panel.

The first jaw and any cradle are thus integrally formed by the appropriate integer and/or the indirect mounting means (e.g. board or panel) by which the second jaw is pivotally mounted on the external structure.

The second jaw may be pivotally mounted on pivotal mounting means, e.g. brackets or trunnions on the appropriate integer and/or the indirect mounting means (e.g. board or panel) by which the second jaw is pivotally mounted on the external structure.

The second jaw may be no more than a single arm with a single pivot, and may e.g. be L- or C-shaped. Alternatively, it may be provided with two pivots at opposite ends of e.g. a C- or U-shaped arm, or a square or oblong equivalent thereof. As noted above, in the carrier device, the second jaw may be a series of separate integers, or a series of connected rigid members, such as bars, rods, rails or rungs, which form a framework, chassis or scaffold.

Thus, the second jaw may be a series of connected members, such as connected arms, often two arms, one towards the top end of the rear of the carrier container or structure, and the other towards the base.

To enable the desired movement within the device, the arms may be connected, e.g. by one or more longitudinal connectors, such as rigid bars, poles, rails, or rods.

These run generally at right angles to the transverse arms which form the second jaw, and each is pivotally mounted on the arms, often between only a pair of arms, respectively towards or at the top end and bottom end of the device.

Where there are several connectors and/or arms, they effectively form a cage structure around the equipment that is slid between and held by the first and second jaws and any cradle in use, when the jaws of the device are rotated to a closure position to hold the equipment.

Alternatively, the second jaw (which may comprise a movable cover) may be pivoted to rotate on at least two pairs of arms that are pivoted on the appropriate upright integer and/or the indirect mounting means. To assist the protection afforded by the device, it is preferred that one pair of only two pairs of arms is mounted towards the top end of the carrier device, and the other is mounted towards the bottom end of the carrier device.

Most preferably, the arms that are pivoted on the two jaws of the device according to the present invention are characterised by having the same dimensions and configurations, so that rotation gives the first and second jaws mutual parallel motion.

In use, the second jaw spans the equipment, such as a pressurised fluid container, and urges it into the first jaw or any cradle.

One or both jaws, usually the movable jaw, of the device is/are provided with at least one locating means, e.g. a foot or base projecting inwardly of the bottom end of the jaw(s) of the device, or a strap, lashing or tie to the other jaw, to locate one end of the equipment longitudinally between the jaws. When the carrier device is used in upright fashion such means are essential to support the bottom end of the equipment on the relevant jaw(s).

Accordingly, a preferred embodiment of the present invention is characterised by a second jaw pivotally mounted directly on an external structure or on a mounting means in turn mounted directly on an external structure such that The first jaw and any cradle are integrally formed by the external structure or mounting means; and

at least one locating means on and projecting inwardly from the second jaw, which locates the equipment between the jaws,
such that in use of the device, when the equipment presses on the locating means it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws.

It will be seen that the weight of the equipment on the locating means on and projecting inwardly from the second jaw assembly will cause the second jaw to close with respect to the first jaw under gravity and urges the equipment into the first jaw and/or any cradle to hold the equipment.

In this mode of use of this embodiment of the device of the present invention described above, where the second jaw comprises at least two arms or pairs of arms that are pivotally mounted directly or indirectly (e.g. mounted on a board or panel that is directly mounted) on an external structure, such a foot or base projecting inwardly of the jaws of the device is usually on the lowermost part of the relevant jaw(s).

Where the second jaw comprises a number of arms optionally connected, e.g. by one or more longitudinal connectors, the foot or base projecting inwardly of the jaws of the device may be extended over any proportion of the lowermost arm.

The arm and the foot or base may together form a bowl, cup or saucer configured to receive the lowermost part of the equipment, such as a pressurised fluid container when the arms drop down under gravity.

Once the jaws close on the equipment, the device may be latchable to retain it securely.

In an alternative embodiment, the second jaw may be slidingly mounted on the first jaw, with its cradle for holding the equipment. It may be mounted on one or more retractable arms running generally at right angles to the first jaw, and housed in cooperating sleeves in or on the first jaw.

Usual and preferred forms and features of this type of the device and its mode of use are as so described with respect to the pivoted type of device hereinbefore.

Thus, the carrier device may be used in upright, inverted or lateral laid-down or suspended fashion, with the mounted (“static”) jaw of the device

when in upright or inverted fashion (top end or bottom end uppermost) being on an upright integer, such as a bulkhead, divider, panel, partition, riser, screen or wall;
when in lateral laid-down fashion, being on a generally horizontal integer, such as a bottom panel, base plate, floor or stand, or flooring; and
when in lateral suspended fashion, being on the underside of a generally horizontal integer, such as a ceiling, cover, lid, roof or top panel.

However, the equipment cannot usually be held under gravity in such a device. Again, the jaws may be urged together by other means, such as spring bias. Alternatively (or additionally) the jaw of the device may be pushed together, and then fastened, e.g. latched or locked to hold them in a position to hold the equipment in place.

The sliding mounting means may comprise friction sliding sleeves housing the arms to govern sliding of the arms inwardly and outwardly of the first jaw.

Preferably, the second jaw is provided with a handhold by which it may be moved. This may as appropriate be a recessed handhold, e.g. integrally formed in and towards the top end of the second jaw, or a handle projecting outwardly of the second jaw at the same position.

Sensitive and/or fragile equipment, such as pressurised fluid containers, is thus securely located by the carrier device, in particular during transport and/or manoeuvring of the laden device, but is readily removable when necessary. In addition, it is preferred that the carrier device has a sturdy protective design, described further below, so that the equipment is protected from damage during storage, and in particular in accident situations, emergencies, in rough conditions of use by emergency and/or accident personnel and/or in a range of trying environments. It is also preferred that the carrier device components, such as the jaws and the cradle in use not only define a stout rigid enclosure around the relevant equipment, but are also lightweight.

A preferred carrier device has a second jaw which comprises a movable cover which is pivoted to rotate on at least two pairs of arms that are pivoted on the first jaw and spans the cradle for holding the equipment.

In a device that is more preferred, two pairs of arms are pivoted on the two jaws, which are elongate in the same direction, respectively at the top end and bottom end of the two integers, corresponding to the top end and bottom end of the device.

Most preferably, the arms that are pivoted on the two jaws of the device according to the present invention are characterised by having the same lengths between pivots, so that rotation gives the first and second jaws mutual parallel motion.

The arms which are pivotally mounted on the jaws are often generally flat, although they may be bars, rods or tubes. They are often straight, but may alternatively be curved, e.g. a shallow C- or U-shaped arm. Most preferably, the arms have the same dimensions and configurations.

Where the present device is so configured and adapted that it has two jaws which are elongate in the same direction, and two pairs of arms preferably pivoted respectively at the top end and bottom end of the two jaws, characterised by having the same lengths between pivots, so that rotation gives the first and second jaws mutual parallel motion, it will be seen that when the jaws close, they hold and support any equipment that is elongate in the same direction, such as a pressurised fluid container, simultaneously along a significant proportion of the equipment length.

This offers a significant advantage over carrier devices used hitherto, which have a second jaw which is a single transverse arm, in that they easily and safely secure the items in position, whilst ensuring that the equipment is readily releasable and removable when necessary and access to the ancillary equipment of e.g. a pressurised fluid container, e.g. its control valve, pressure gauge, gas supply tube and regulator device, is not hampered.

This is especially the case when such equipment is to be held upright in a carrier device used in upright fashion, i.e. in unstable equilibrium, especially if the equipment has a rounded bottom end like some gas cylinders.

The weight of the equipment itself acts to topple it out of the first jaw and any cradle.

Further advantages include that the device may be used with equipment of widely varying shape and size, or indeed that are not of a complementary shape to the device, and that the jaws and arms effectively form a protective cage structure around the equipment that is slid between and held by the first and second jaws and any cradle in use.

It will be seen that when any of the foregoing devices is in use, the first jaw and the cradle, the second jaw and the cover, and the arms connecting them form a generally cuboidal (or rhombocuboidal) rigid enclosure.

At least some of the equipment, such as a pressurised fluid container is located in this enclosure to protect it from damage during storage, transport and/or manoeuvring of the laden device.

When the carrier device is used in an upright fashion, an upstanding rear wall is effectively formed by the first jaw and the cradle, a front wall by the second jaw and the cover, at least partially open opposite side walls by the arms connecting them, and at least partially open bottom end by the foot or base projecting inwardly of the jaws of the device. The enclosure has an open top.

The cuboidal rigid enclosure may extend over any proportion of the equipment, such as pressurised fluid containers, depending on the relative lengths of the first and second jaws and the equipment. Each jaw is preferably of a size approximately the same as that defined by the equipment, such that they do not extend beyond it by too great a degree.

If it is desired to further protect the equipment, from damage during storage, transport and/or manoeuvring of the laden device, the proportion of the top, part side walls and part bottom end of the device may be increased.

Thus, any foot or base projecting inwardly of the jaws of the device may be extended over any proportion of the bottom end of the device, provided that the first and second jaws can still hold the equipment.

If it is desired, the bottom end of the device may be provided with one or more straps of a strong yet flexible material between the jaws of the device, and running generally in the same direction as, or across each other, e.g. to form a net, mesh, web or woven structure on the bottom end of the device.

Alternatively, one or more pieces of a strong yet flexible sheet material between the first and second jaws may close at least a part of the bottom end of the device.

Accordingly, a preferred embodiment of the present invention is characterised by a second jaw which comprises a movable cover which is pivoted to rotate on two pairs of arms that are pivoted on the first jaw and spans the first jaw or any cradle for holding the equipment, and the two jaws, which are elongate in the same direction,

the pairs of arms that are pivoted on the two jaws of the device being respectively at the top end and bottom end of the two jaws, and having the same lengths between pivots, so that rotation gives the first and second jaws mutual parallel motion; and
at least one locating means on and projecting inwardly from the second jaw, which locates the equipment between the jaws,
such that in use of the device of the present invention described above, when the equipment presses on the locating means it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws.

It will be seen that the weight of the equipment on the locating means on and projecting inwardly from the second jaw assembly will cause the second jaw to close with respect to the first jaw under gravity and urges the equipment into the first jaw and/or any cradle to hold the equipment.

The part side walls may be provided with further arms pivoted on the two jaws of the device, and running generally in the same direction as, and preferably mutually parallel to, the existing arms.

Any connectors pivoted on the arms of the device on each side may be rigid, and usually of the same material as the arms and/or jaws, or of a strong yet flexible material, such as may be used between the first and second jaws to close at least a part of the bottom end of the device.

The carrier device may also have a lid which fits over at least a part of the open top and further protect the contents during storage, transport and/or manoeuvring of the laden device. Such a lid can be shut when the device is in use and opened when it is not, e.g. for loading equipment to be held, such as a pressurised fluid container, which is slid between the jaws. When the carrier device is used in inverted fashion such a lid is essential to support the top end of the equipment housed in the jaws.

Such a lid may be totally removable from the carrier device, e.g. it may be of a complementary shape to the carrier device and may slide thereover, or it may be hinged or pivoted on one or (in two parts) both jaws of the device, to rotate to a closure position, and be held by appropriate catch mechanisms.

Alternatively (or additionally) as for the bottom end of the carrier device, the lid may be a belt or strap, or a net, mesh, web or woven structure, or a sheet of a strong yet flexible sheet material mounted on one of the first and second jaws of the device, and be held by appropriate catch mechanisms on the other jaw, when in use.

The lid may be an integer that is mounted on or integrally formed as part of, and is static in relation to, one or (in two parts) both jaws of the device, so that it moves to a closure position, with the relative movement of the first jaw and second jaw. Thus, a projection inwardly of the jaws of the device, such as a flange, brow, lip or rim may be provided towards or at the top end of one or both jaws.

Any lid if present may cover all of the top end of the device, and the equipment, such as a pressurised fluid containers, therein in use.

Alternatively, the equipment, e.g. may have a neck extending outwardly from the top end of the device in use, and a collar or shoulder extending transversely around the neck, as is often found in pressurised fluid containers. Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws.

In such cases, the lid or each part lid of the device (whether static or movably mounted on the jaw(s)) may be configured to locate at least partly around the neck and/or over the collar or shoulder extending transversely around the neck, when in a closure position.

Thus, e.g. the lid or each part lid of the device may be configured with an indentation or notch to locate at least partly around the neck and/or over the collar or shoulder.

In this way, one can secure a gas/oxygen cylinder for use in inverted fashion (bottom end uppermost), especially at an emergency and/or accident site.

Advantageously, access to the ancillary equipment of the pressurised fluid container, e.g. its control valve, pressure gauge, gas supply tube and regulator device, is not hampered.

If it is desired to protect such ancillary equipment from damage during storage, transport and/or manoeuvring of the laden device, a proportion of

the rear wall effectively formed by the first jaw and the cradle,
the front wall effectively formed by the second jaw and the cover, and
the at least partially open opposite side walls effectively formed by the arms connecting them,
may extend beyond the shoulder to shroud the neck and ancillary equipment of the pressurised fluid container.

In the same way, one can secure an inverted refreshments dispenser, e.g. for food or drink, such as an optic bottle for use in inverted fashion, e.g. in a bar or public house, mounted on a stand or wall.

As noted above, when the carrier device is used in inverted fashion such a lid is essential to support the top end of the equipment housed in the jaws. Equally, such a lid may be desired for security when sensitive and/or fragile and/or potentially dangerous equipment, e.g. a pressurised fluid container is stored in a position that may be inverted, e.g. in an emergency and/or accident, such as a fire extinguisher in a vehicle, or potentially dangerous equipment in transit in industrial, commercial or military transportation.

As noted above, the foregoing devices may be used generally in upright fashion and with an open top (i.e. no lid which fits over the open top) to secure items together temporarily, such as

components of a temporary but rigid framework, chassis, lattice, scaffold, bulkhead, divider, panel, partition, screen or wall, e.g. for
a covered entrance, exhibition area, gazebo, marquee, pavilion, portico, tent or other temporary accommodation, building, construction or structure, or
a spectator area or other temporary space, or
temporary fencing or scaffolding, or
fixing temporary advertisements, billboards, directions, display boards, hoardings, notices, signs and signboards to a framework, chassis, lattice, scaffold, bulkhead, divider, panel, partition, screen or wall.

They have the advantage that they easily and safely secure the items in position, whilst ensuring that the items are not damaged and are readily releasable and removable when necessary. Additionally, they can be used in general with items of widely varying shape and size, or indeed that are not of a complementary shape to the device.

Thus, they may be used in the construction of a rigid fence, enclosure, screen or wall comprising a framework or scaffold consisting of a series of upright integers, such as two or more rigid poles, posts, shafts or stakes, each pair being connected, e.g. by one or more generally horizontal integers, such as rigid bars, beams, girders, joists, rails, rods, spars or ties.

Typically, two of the foregoing devices are mounted by their first jaws facing each other at roughly the same level on opposing faces of adjacent upright integers. A generally horizontal integer is provided with two transverse downwardly pointing arms, mounted respectively at each of its ends.

In use of the devices, an upward pull on the second jaw of each device causes the jaws to open, each transverse downwardly pointing arm mounted respectively at each of the ends of the generally horizontal integer is slid between the first and second jaws and any cradle, and the jaws of the device then allowed to return to a rest position under gravity, so that the jaws hold the generally horizontal integer. The process is reversed to readily release the latter.

Each upright integer is typically provided with multiple, e.g. two or three, devices mounted on the same face and facing corresponding devices mounted on an opposing face of an adjacent upright integer. Thus, the pair are connected, e.g. by two or three generally horizontal integers at different levels to effectively form a framework structure.

To form a more flexible construction system, e.g. for temporary fencing which needs to follow the ambient terrain and/or for manoeuvring the integers in difficult confined spaces, the transverse downwardly pointing arms mounted respectively at each of the ends of the generally horizontal integer may be pivotally mounted.

The devices may be used to secure other items together temporarily, such fixing temporary advertisements, billboards, directions, display boards, hoardings, notices, signs and signboards to a framework, chassis, lattice, scaffold, bulkhead, divider, panel, partition, screen or wall.

Typically, two of the foregoing devices are mounted by their first jaws on the same face of one or more upright integers facing outwards at roughly the same level.

The item to be fixed to the upright integers has two fixed downwardly pointing lugs, mounted on its rear face.

In use of the devices, an upward pull on the second jaw of each device causes the jaws to open, each downwardly pointing lug mounted on the rear face of the item to be fixed to the upright integer(s) is slid between the first and second jaws and any cradle, and the jaws of the devices then allowed to return to a rest position under gravity, so that the jaws hold the generally item to be fixed. The process is reversed to readily release the latter.

The supporting item may typically provided with multiple, e.g. more than two devices mounted on the same to hold corresponding devices lugs mounted on the rear face of the item to be fixed.

The devices may also be used to securely hold other items together temporarily, such as

for stowing documents, manuscripts, notes, papers, scripts, publications, such as books, pamphlets, periodicals, such as journals, magazines, newspapers and reviews, or
for holding empty or laden refreshments containers or tools, e.g. for food or drink, such as tableware, including crockery such as cups, mugs, saucers dishes and plates, glasses, and cutlery, and beakers, plastic and paper cups, cartons, packs, packets, tubs, jars and pots for beverages, hot and cold drinks, snacks, and food,
often mounted on a bulkhead, divider, panel, partition, screen or wall.

The latter may be in a static structure, such as a house or place of work, such as an office, or a refreshments establishment, such as a café, restaurant, snack bar, bar, hotel, or public house, where it is often mounted on a stand or wall.

Alternatively, it may be in private, industrial, commercial or military transportation, e.g. a road vehicle, such as a car, coach, heavy goods vehicle, such as a lorry, wagon or truck, or van, or in a railway vehicle, such as a carriage or locomotive, or in aircraft, such as airplanes and helicopters, where it is often mounted on or by a control panel, console, dashboard, instrument panel bulkhead, divider, panel or partition.

Such a carrier device of the present invention, configured and adapted to embrace and hold multiple items of equipment is particularly useful. A bank of such devices may be mounted, often in parallel alongside each other. A bank of such devices may be configured such that each carrier device may be operated independently. Alternatively, any of the devices may be attached to another device, so that the relevant carrier devices operate with each other.

Another embodiment of the present invention is a carrier device, characterised in that it comprises a movable cover which is pivoted to rotate on at least two pairs of arms that are pivoted on the first jaw and spans the first jaw and any cradle, for holding the equipment, and in that each arm is a composite arm which comprises at least two part arms that are pivotally mounted on each other.

Preferably, all the part arms in the device according to the this embodiment are characterised by having the same lengths between pivots, so that rotation gives the first and second jaws mutual parallel motion which is symmetrical about the mid-point pivot of each arm and the equipment in the device.

This carrier device often has two pairs of arms, one towards the top end of the carrier structure, and the other towards the base. To control the desired parallel motion within the device when the jaws of the device are rotated to a closure position to hold the equipment, the two pairs of arms may be connected, e.g. by one or more longitudinal connectors, such as rigid bars, poles, rails, or rods, being pivotally mounted on the arms.

These often run between only a pair of arms, respectively towards or at the top end and bottom end of the device, and often (where there are only one or two such connectors and/or arms) on the mid-point pivot of each arm, and running generally parallel to the first and second jaws and any cradle.

Where there are several connectors and/or arms, they effectively form a cage structure around the equipment that is slid between and held by the pairs of arms, one towards the top end of the carrier structure, and the other towards the base.

In such a device, any locating means, e.g. a foot or base projecting inwardly of the bottom end of the jaw(s) of the device to locate one end of the equipment longitudinally between the jaws and/or to support the bottom end of the equipment may be mounted on one or both of the first jaw and second jaw.

In one form of this embodiment of the device of the present invention described above, however, the locating means, e.g. a foot or base projecting inwardly of the bottom end of the jaw(s) of the device, may be mounted on one or more connectors at or towards the lower end of the carrier structure generally extending inwardly of the jaws of the device.

It may thus be a horizontal integer, such as a bottom panel or base plate, at an angle, often at right angles, to one or more longitudinal connectors.

In a preferred form, opposing longitudinal connectors will be mutual mirror images which are symmetrical about the mid-line of the jaws of the device. The locating means may be mounted on and extend inwardly of the jaws of the device between two such longitudinal connectors.

In a more preferred form, the relevant longitudinal connectors may be pivotally mounted on the mid-point pivot of each arm of a pair of arms towards or at the bottom end of the device.

Any foot or base projecting inwardly of the jaws of the device may be extended over any proportion of the bottom end of the device, provided that the first and second jaws can still hold the equipment.

It will be seen that when the carrier device is used in upright fashion rotation downwardly about the mid-point pivot of each part arm causes generally parallel downward motion of the first and second jaws and opening of the jaws. The equipment, such as a pressurised fluid container, may then be slid between and held by the first and second jaws and any cradle, and the jaws of the device then allowed to return to a rest position under gravity, so that the jaws hold the equipment.

The jaws may each be provided with an integer which extends upwardly to form a carrying handle.

In use of the device, after the equipment has been slid between the first and second jaws into any cradle, an upward pull on the handles which is appropriate for carrying the device causes the jaws to close to hold and support the equipment, such as a pressurised fluid container.

Placing the carrier on its locating means, e.g. a foot or base projecting inwardly of the bottom end of one or more central connectors, on a surface will cause the arms to drop down under gravity and provide an automatic quick release of the equipment, such as a gas cylinder, e.g. for medical gases such as oxygen or anaesthetic gases, in its intended final place.

If this is not desired, in this mode of using the device, the jaws may be urged together by other means, such as spring bias, and/or latched or locked to hold the laden carrier device in a closure position by appropriate catch mechanisms.

A preferred embodiment of the present invention is characterised in that

it comprises a movable cover which is pivoted to rotate on at least two pairs of arms that are pivoted on the first jaw and spans the first jaw and any cradle for holding the equipment,
each arm is a composite arm which comprises at least two part arms that are pivotally mounted on each other, and
it comprises at least one locating means on and projecting inwardly from the second jaw, which locates the equipment between the jaws,
such that in use of the device, when the equipment presses on the locating means against the reaction of the jaws, it causes the jaws to close to hold and support the equipment.

Where the equipment is elongate, such as a pressurised fluid container, the locating means will generally engage with one end of the equipment, to locate the equipment longitudinally between the jaws.

Urging the equipment longitudinally between the jaws against the locating means will cause the jaws to close to hold and support the equipment.

When the carrier device is used in upright fashion, i.e. with the first jaw holding the equipment upright, such means support the bottom end of the equipment which is held in between the jaws.

It will be seen that the weight of the equipment on the locating means on and projecting inwardly from the second jaw assembly will cause the second jaw to close with respect to the first jaw under gravity and urges the equipment into the first jaw and/or any cradle to hold the equipment.

In a preferred embodiment of the present invention, two, often identical and often elongate, devices are mounted head to head (top end to top end) to extend in opposite directions. At least one jaw, usually the movable jaw, of each device is/are provided with a locating means, e.g. a foot or base projecting inwardly of the bottom end of the jaw(s) of each device.

When the pair of carrier devices is mounted and used in upright fashion, it will be seen that the feet are at opposite ends of the assembly.

One serves to support the bottom end of the equipment on the relevant jaw(s), and the other as a lid; these form a good protective enclosure during normal storage or transport, and when tilted or inverted in hazardous situations, such as accidents.

The two devices may be so arranged that when the arms are in their rest position, they all hang down, and the jaws are closed, and the second jaws are connected, e.g. by a handle of relatively simple construction. In use of the device, the second jaws are lifted by means of the handle, so that the arms are rotated to a use position outwardly of the first jaws. After the equipment has been slid between the first and second jaws into the cradle, the second jaws of both the devices are rotated to a closure position to hold the equipment.

Alternatively, the two devices may be so arranged that when the arms are in their rest position, those on the lower device hang down, and those on the upper device extend upwardly, and the jaws are closed. The devices are connected by at least one pair of two mutually pivoted arms, in turn pivotally mounted on the second jaws to form a pantograph. These arms may be provided with an optionally projecting handle.

In use of the device, the arms are rotated to a use position outwardly of the first jaws by pulling outwardly on the handle, e.g. at right angles to the overall assembly.

After the equipment has been slid between the first and second jaws into the cradle, the second jaws of both the devices are rotated to a closure position by ceasing the outward pull on the handle.

In such a version of this embodiment, the jaws are usually configured and adapted to be latched or locked to hold the unladen carrier device in a closure position against gravity by appropriate catch mechanisms.

Such assembly embodiments are particularly useful in situations where the device is to be used for holding sensitive and/or fragile equipment, such as pressurised fluid containers, that are to be carried in vehicles, other than by way of industrial or commercial transportation of such equipment.

For example it may be mounted in a road vehicle, such as a car, coach, heavy goods vehicle, such as a lorry, wagon or truck, or van, or in a railway vehicle, such as a carriage or locomotive, or in aircraft, such as airplanes and helicopters, to hold a pressurised fluid container, such as a fire extinguisher.

It may also, for example, be mounted in railway vehicles and other road vehicles, such as an emergency and/or accident service or military vehicle, such as a police, fire or medical vehicle, for use by doctors, first aiders, midwives or paramedics, to hold a pressurised fluid container, such as a gas cylinder, e.g. for medical gases such as oxygen or gases such as the anaesthetic sold under the trade mark Entonox and Equanox.

Such carrier devices in a road or railway vehicle may be mounted in upright fashion on an upright integer.

In railway vehicles, it may be mounted in upright fashion on an upright integer, such as a front or other transverse, or a side or other longitudinal, bulkhead, partition, panel, divider or wall in or around the driver, passenger or communication spaces of the vehicle.

In road vehicles, it may often be provided with a bottom mounting on a base, flooring, such as a floor pan, or stand. In addition, to assist in its support it may be further provided with means to allow the carrier device to be supported towards or at the top end on an external structure. Such attachment means may take a variety of forms dependent on the item on which the device is supported.

It may be supported on the back or front face of a transverse bulkhead, partition, panel, divider, wall or other like integer in or around the driver or passenger space of the vehicle, or on the inner face of a longitudinal bulkhead, partition, panel, divider or wall in or around the same space.

Preferably, it is supported on the back face of a front seat or the front face of a back seat, when the means to allow the carrier device to be supported on the external structure may be means to sling the device about, attach it to or engage it with headrest supports on the respective seat.

Alternatively (or additionally), in road and railway vehicles, such a carrier device.assembly, usually configured and adapted to be latched or locked to hold the carrier device in its working and closure positions against gravity by appropriate catch mechanisms, may be mounted on the underside of a generally horizontal integer, such as a ceiling, cover, lid, roof or top panel, in or around the respective driver, passenger or communication spaces.

To form a good protective enclosure during storage, transport and/or manoeuvring of the laden device and/or in hazardous situations, such as accidents, it is desirable to physically strengthen the rigid parts of the carrier device. In a preferred embodiment of the present invention, the second jaw comprises a movable cover, and both jaws are elongate and extend in the same direction, often generally parallel to each other.

The second jaw may be integral with the cover, and the first jaw may be integrally formed with the cradle for holding the equipment. The two jaws may each be a rigid generally flat plate in outline.

One or both jaws may desirably be physically strengthened by providing them with projections such as flanges at right angles to the overall plate, e.g. around its rim and/or across one or both of their two substantially flat faces. The arms may conveniently be pivoted on positions on such projections at right angles to the overall plate and around its rim.

For strength, the rigid parts of the carrier device are formed from high strength plastics, such as ABS (acrylic butyl styrene) Bayblend Charpy™ or polycarbonates, carbon fibre composite material or duralumin or mild steel sheet material, as each offers excellent strength to weight ratios.

Not least because of its use on site in emergency and/or accident situations, it is preferred that the carrier device is electrically non-conductive.

High strength plastics, such as ABS (acrylic butyl styrene), Bayblend Charpy™ or polycarbonates, are preferably used in construction, since these are non-conductive materials

The first jaw is provided with a cradle for holding the equipment, and the second jaw (which may be integral with a cover) is movably mounted on the first jaw and configured to locate over and at least partly span the equipment and urge it into the cradle.

The first jaw and the cradle for holding the equipment may be different integers, or the first jaw may be integral with the cradle, which may be provided with multiple, e.g. two or three, projections, each cooperating with a cradle for holding an item of equipment.

In such case, the enclosed space defined by the device may be divided by a projection inwardly of one or both jaws between each cradle, to an extent compatible with the holding function of the carrier device, to define and section off regions or compartments, each to house an item of equipment, such as a pressurised fluid container. Such projections inwardly of the jaws of the device may be one or more inner panels or C-bars.

Such panels and/or bars may also be advantageously readily removably mounted in the device, e.g. a bar may have a grooved head at each end and extend through holes formed in a jaw, and be retained by gravity and/or clips.

Multiple items of equipment, such as pressurised fluid containers may each be embraced by and held in a carrier device of the present invention or in a bank of such devices.

Accordingly, an embodiment of the present invention is a carrier device assembly, characterised in that it comprises

at least one first jaw with at least two cradles for holding equipment, and
at least one second jaw, movably mounted on the first jaw and configured to locate over and at least partly span the equipment and urge it into the cradles.

In a first version, a single first jaw is provided with multiple, e.g. two or three, optionally integrally formed cradles for holding the equipment.

The second jaw (which may be integral with the cover) may be provided with multiple, e.g. two or three, projections, each cooperating with a cradle for holding an item of equipment.

In such case, the enclosed space defined by the device may be divided by a projection inwardly of one or both jaws between each cradle, to an extent compatible with the holding function of the carrier device, to define and section off regions or compartments, each to house an item of equipment, such as a pressurised fluid container.

Such projections inwardly of the jaws of the device may be integrally formed by adjacent edges of adjacent cradles, each for holding an item of equipment, optionally integrally formed, or connected, together. Thus, e.g. it may be preferred that each cradle for holding the equipment in the carrier device assembly is formed in the first jaw by a shallow V-channel, running generally in the same direction as, and preferably mutually parallel to, all the other channels.

Alternatively (or additionally), such projections may be one or more inner panels or C-bars mounted on the first or second jaw. Such panels and/or bars may also be advantageously readily removably mounted in the device, e.g. a bar may have a grooved head at each end and extend through holes formed in a jaw, and be retained by gravity and/or clips.

Alternatively, one or more further arms, e.g. a single pair, may be pivotally mounted between the two jaws. These may be mounted the same direction, respectively towards or at the top end and bottom end of the two integers, corresponding to the top end and bottom end of the device. Most preferably, the arms that are pivoted on the two jaws of the device according to the present invention are characterised by having the same lengths between pivots as, and corresponding positions to, the outermost arms. Such further arms may need to be pivotally mounted and partly housed in complementary recesses in the jaws of the device, to permit their rotation in use.

They will also define a series of compartments, each to house an item of equipment, such as a pressurised fluid container.

Often, in use, a single second jaw and/or cover, movably mounted in the device, spans the equipment, such as a pressurised fluid container, and urges it into the cradle. The single second jaw and cover may be no more than a rigid bar, pole, rail, or rod or a generally flat plate, preferably of a size defined by the equipment. Alternatively, it may be formed with a series of integral shallow-V projections or inner panels or C-bars mounted on the second jaw.

Each of such projections, panels and/or bars will in use cooperate with each cradle to hold an item of equipment. The latter may again be advantageously readily removably mounted in the device, as described above.

As described hereinafter in greater detail, the device of the present invention may be installed permanently or removably for replacement in a position on a static or movable external structure. It may be mounted directly or indirectly (e.g. mounted on a board or panel that is directly mounted) on an external structure.

A bank of such devices may be mounted, often in parallel alongside each other, directly or indirectly (e.g. mounted on a board or panel that is directly mounted) on an external structure. A bank of such devices may be configured such that each carrier device may be operated independently. Alternatively, any of the devices may be attached to another device, so that the relevant carrier devices operate with each other.

A carrier device assembly of the present invention, configured and adapted to embrace and hold multiple items of equipment is particularly useful for the industrial or commercial transportation of such equipment.

It is particularly useful for the industrial or commercial transportation of such equipment such as pressurised fluid containers in a road vehicle, such as a heavy goods vehicle, such as a lorry, wagon or truck, or van, or in a railway vehicle, such as a wagon or van.

In such cases, pressurised fluid cylinders will often be carried in a single device mounted in upright fashion on an upright integer, such as a front or other transverse, or a side or other longitudinal, bulkhead, partition, panel, divider or wall in or around the cargo space of vehicle.

The single second jaw and cover may be no more than a framework formed by and comprising:

one pair of longitudinal members, each of which forms its side, and each being pivotally mounted on a pair of arms, running mutually parallel between the two jaws, respectively towards or at the top end and bottom end of the device, and two or more (usually two) transverse arms, each e.g. a rigid bar, pole, rail, or rod or a generally flat plate, mounted, respectively towards the top end and bottom end of the longitudinal members.

Each of the bars that are mounted towards the bottom end of the longitudinal members is configured and adapted to span across, and be fixedly mounted on them, to hold one to the other. Each of the other bars is pivotally mounted on one member and is configured and adapted to span across to, and be latched or locked onto, the other member.

When at rest, the two pairs of arms hang down, and the jaws are closed. In use of the device, each pivoted bar is unlatched or unlocked from one member and pivoted to the other side of the other member. The second jaw is lifted, so that the arms rotate about their pivots on the second jaw, and on two pairs of pivots on the first jaw. Rotation gives the first and second jaws mutual parallel motion and opens them.

The gas cylinders are then slid in between the jaws of the device, to locate one end of the equipment longitudinally between the jaws.

The second jaw is then released, and the arms drop down under gravity. Each pivoted bar is pivoted back to, and latched or locked to the member, so that the first and second jaws close on and retain the equipment.

Such an arrangement provides better access to the equipment than is permitted by a more enclosed cover.

The device of the present invention may be static, i.e. installed permanently or removably for replacement in a position on a static external structure. Thus, it may be the mounted

in upright or inverted fashion (top end or bottom end uppermost) on an upright integer, such as a bulkhead, divider, panel, partition, riser, screen or wall;
in lateral laid-down fashion, on a generally horizontal integer, such as a bottom panel, base plate, floor or stand, or flooring; and
in lateral suspended fashion, being on the underside of a generally horizontal integer, such as a ceiling, cover, lid, roof or top panel.

For example it might be so mounted at an emergency and/or accident or first store and/or transport station in an industrial plant or air, land or sea transportation.

It may be mounted directly or indirectly (e.g. mounted on a board or panel that is directly mounted) on an external structure.

Alternatively, the device of the present invention may be, or be mounted, on a mobile structure. Thus, it may be, or be mounted on a movable external structure that is portable or towable or pushable, such as a trolley, such that it is safe for easy movement by an individual.

Again the carrier device may be if mounted, then mounted directly or indirectly (e.g. mounted on a board or panel that is directly mounted) on the external structure, and either permanently connected to, or totally removable from the external structure.

Where it is a portable device, the carrier device is provided with a handle, so that the device as a whole may be carried by means of the handle to its site of use. The weight of the device, preferably about 6 kg, is light enough to be easily carried by any one person.

To assist one handed carrying, a single handle on an upper part of the carrier device is preferred, e.g. at or near the upper end of the first jaw, or where the jaws of the device are readily releasably latched or locked to hold them in a use closure position, to any lid the carrier device may have.

It is preferred that the carrying handle is displaced or displaceable inwardly of such mountings to be relatively vertically, and preferably as nearly vertically as possible, above the centre or gravity of the fully laden device. This arrangement provides better balance when transported by hand.

A permanently off-set handle offers better strength and relatively simple construction. On the other hand, it may be desirable or preferred to adapt the carrier device to be better balanced for different weight distributions within the carrier device when transported by hand. For example, one or two cooperating (preferably one) flip-down handles may be mounted on a suitable part of the first jaw or the lid, in such a way that it may be readily rotated into its use position.

The mounting means may comprise hinging, pivoting, sliding or retractable arms that are configured and adapted to be latched or locked to hold them in a position as nearly above the centre or gravity of the fully laden device as possible. The latch may be able to hold them in several positions. For example, an arm may have a projection cooperating with several notches preventing its further rotation on an arcuate member mounted on a suitable part of the external surface of the rear wall and/or one or both side walls, with a clamp screw.

Another embodiment of the present invention is a carrier device, characterised in that it is a towable or pushable structure.

The towable or pushable device may be provided with at least one, and preferably at least two, preferably lightweight, rolling means, and preferably one pair thereof. The rolling means often include one or two (preferably one) pairs of rollers or wheels.

The towable or pushable carrier device may take a variety of forms dependent on the equipment, e.g. a pressurised container, such as a gas cylinder, which the device is to carry.

In one version of this embodiment, the device is intended for medical and/or emergency and/or accident purposes for the transport of a gas cylinders e.g. for oxygen and/or gases such as the anaesthetic sold under the trade marks Entonox and Equanox, and also other elongate items of apparatus which may need to be carried by medical, emergency and/or accident personnel.

Such a device is often the preferred embodiment of the present invention described above with a second jaw which comprises a movable cover which is pivoted to rotate on two pairs of arms that are pivoted on the first jaw and spans the cradle for holding the equipment.

Preferably, the two pairs of arms that are pivoted on the two jaws of the device according to the present invention are characterised by having the same lengths between pivots, so that rotation gives the first and second jaws mutual parallel motion.

Preferably, the first jaw and the cradle are integral, and the second jaw is integral with the cover, the first jaw and cradle for the equipment and the second jaw and cover are elongate in the same direction and roughly co-extensive.

One pair of the two pairs of arms is mounted towards the top end of the carrier device, and the other is mounted towards the bottom end of the carrier device.

The carrier device is used in upright fashion to hold the lowermost part of the equipment, such as a pressurised fluid container when the arms drop down under gravity. Thus it also has a foot or base projecting inwardly of the jaws of the device, generally at right angles to the jaws, or a strap, lashing or tie to the other jaw, to locate one end of the equipment longitudinally between the jaws and support the bottom end of the equipment on the relevant jaw(s).

Once the first and second jaws close on the equipment, the device may be latchable to retain it securely.

When the carrier device is used in an upright fashion, an upstanding rear wall is effectively formed by the first jaw and the cradle extending in the same direction as the equipment.

A transverse footplate or bottom end projecting at an angle, often at right angles, to the rear wall, is formed by the bottom face of the same integers and by the foot or base projecting inwardly of the jaws of the device.

The rolling means may be installed in a permanent position, and may extend beyond the device by whatever degree is required and convenient in the operation of this embodiment. In a preferred form suitable rolling means include one or two (preferably one) pairs of rollers or wheels mounted on or in the junction of the rear wall and the base plate.

If the device is intended to store and/or transport pressurised fluid containers in industrial and commercial premises or hospitals or their immediate surroundings, i.e. in circumstances where the route to a use location is over relatively easy terrain, the rolling means may project to any degree necessary.

However, the device may be intended for medical and/or emergency and/or accident purposes, in circumstances where, e.g. part of the route to a use location may be over relatively easy terrain, but part involves it being dragged over a rough surface to any great degree.

The rolling means should not then hamper the movement and manoeuvring to and from the patient in a range of trying environments.

Thus, it is then preferred that any such rolling means do not extend beyond the device by too great a degree, or that they be retractable into the device.

Such rolling means may be installed in a permanent position, in which case it is preferred that they be recessed into the carrier device, e.g. housed in complementary recesses in the carrier device, and turning on axles or spindles that span the recesses into the carrier device, such that the carrier device can be still be readily dragged over a rough surface.

If the rolling means are mounted on or in one or both of the rear wall or base of the carrier device, the junction of these may be rounded substantially concentrically with the rolling means to facilitate dragging.

Alternatively, the rolling means, e.g. one or two (preferably one) pairs of rollers or wheels may mounted to turn on axles or spindles on arms that may be pivotally and/or slidably and/or retractably mounted on, e.g. the rear wall. Then, when the arms are in their rest position, the rolling means are, e.g. housed in complementary recesses in the carrier device. Each may be locked in its use and stored positions.

The arms when required, can be rotated or slid to a use position outwardly, e.g. of the rear wall or the base plate of the device, optionally with a cooperating spring bias and/or damping.

They may them be returned to the rest position when the device needs to be dragged over a rough surface, or when in use on a patient requiring pressurised fluid containers.

Where the arms are slidingly retractable, the mounting means may comprise friction sliding sleeves housing the arms to govern lateral sliding of the arms to extend them outwardly of the device.

It is advantageous that once used and once the equipment has been removed, the device collapses into a small, relatively thin volume for storage.

In use, the laden device may be towed or pushed on its rolling means by means of the upper part of the equipment, e.g. a pressurised fluid device, such as a gas cylinder, e.g. in the latter case by means of the usual guard structure around its neck and valve gear.

A fire extinguisher, however, or equipment, e.g. ordnance, such as a small shell, may not be provided with such convenient handholds and/or may be inconveniently short or long or have handhold at an inconvenient height for towing.

Accordingly, it may be desirable to provide the device with a towing or pushing handle that is or is extendible to a convenient towing or pushing height. A single such handle on the rear wall of the device is preferred, e.g. at or near the upper end of the rear wall.

This may be a straight or U-bar, rod or tube. It may be advantageous that it is provided with (usually) one extendable and retractable and/or removable handle, e.g. one slidably mounted on the device or a fixed telescopic tubular handle. Each may be held in its extended use position by sliding friction between the telescopic sleeves, and/or locked by a clamp.

Once at its use destination, the laden device may be stood and rested on its bottom end. If the surface is uneven, as the centre of gravity of the whole is relatively high above a relatively narrow base, the present device may be further provided with two or more stabilising means.

These may be arms or feet, which can project outwardly from the device in different directions, or two or three (preferably three) elongate flip-out retractable stabiliser supports, such as legs, props or struts, which can project outwardly from the device in different directions.

Alternative stabilising means may take a variety of forms, but include an inertia reel strap on an adjacent wall, as used in car front seat belt or strap, around the gas cylinder, device. This holds it safely, but in such a way that it may be readily accessible and then rolled away.

Several such devices may be configured and combined to form a carrier device assembly comprising at least two cradles for holding equipment, as described above, with common rolling means.

In one version, a single first jaw is provided with multiple, e.g. two or three, optionally integrally formed cradles for holding the equipment.

The second jaw (which may be integral with the cover) may be provided with multiple, e.g. two or three, projections, each cooperating with a cradle for holding an item of equipment.

In such case, the enclosed space defined by the device may be divided by a projection inwardly of one or both jaws between each cradle to define and section off spaces or compartments, each to house an item of equipment, such as a pressurised fluid container.

In another version, several devices, each used for holding one item of equipment, and urging it into one cradle may be mounted side by side, and have common rolling means.

Preferably, each carrier device in the towable or pushable structure operates independently. Alternatively, any of the devices may be attached to another device such that the relevant carrier devices operate with each other.

Again, suitable rolling means include one or two (preferably one) pairs of rollers or wheels, mounted on or in one or both of the rear wall or base of the carrier device.

As one intended purpose of the device for holding sensitive and/or fragile equipment, such as pressurised fluid containers, is in emergency and/or accident situations, it may be required to manoeuvre the device into difficult confined spaces.

To achieve this, the carrier device in use should desirably have few or no features that provide anything that will snag on the environment in in-the-field situations, or otherwise hamper the movement and manoeuvring of the device to and from the patient, and preferably it should be streamlined.

It may thus be desirable to at least partially enclose a carrier device or a carrier device assembly (capable of holding multiple items of equipment) by a container, such as a box, casing or sheath, or other covering, optionally with a lid which fits over the open top.

Such a container may be of a complementary shape to the carrier device or carrier device assembly and may enclose it, provided that the device or carrier device assembly can still rotate to and from a closure position within it.

Often the container comprises a generally cuboidal box with a base having an integral upstanding rear wall and side walls and a front wall, defining a rigid and optionally partly open-fronted enclosure that is enclosed on five sides. The front wall may extend over any proportion or all of the front face. The carrier device or carrier device assembly may often be mounted directly or indirectly (e.g. mounted on a board or panel in turn mounted) on the rear wall, or less often on one of the side walls, of the carrier container.

Although such a container may be configured to locate over, span and hold one item of equipment, and urge it into one cradle, it is particularly useful in situations where the device is to be used for holding multiple items of equipment, i.e. it is a carrier device assembly comprising at least two cradles for holding equipment, mounted side by side. Such a generally cuboidal box container may then have an oblong, rather than a square base and an integral upstanding rear wall and front wall which are longer than the side walls, so defining a rigid enclosure that is broader than it is deep.

This may provide a substantially flat face on which the contained device or carrier device assembly can be more stably dragged e.g. by a single handle on an upper part of the container, as described below, during such manoeuvring, or a junction of two faces, e.g. of the base and integral upstanding rear wall which may be rounded to serve as a better surface for sliding, on which the device or carrier device assembly as a whole can be dragged, and/or be relatively streamlined.

The container may also have a lid which fits over the open top and further protect the contents during transit.

Such a lid may be of a complementary shape to the carrier device or carrier device assembly and may slide thereover, and might be totally removable from the carrier device container (as it is known herein, regardless of whether it contains a device or an assembly of devices).

Alternatively, such a lid can be permanently connected to the carrier device container, and be openable by hinging, sliding or other mechanisms, and be held by appropriate catch mechanisms.

When in place the lid and carrier device container would substantially wholly contain the other cylinder to protect them from damage. When the lid is open, the carrier device container may continue to protect at least a part of the equipment, but access to the equipment is permitted.

The enclosure that may be defined by the carrier device container can be totally rigid or it may be partially rigid with strong yet flexible material forming some parts. A protective enclosure may thus be formed by rigid parts of the carrier device container, i.e. the base and walls of the container, and further flexible parts, e.g. the lid if present, in combination.

It is preferred that the carrier device container and lid if present are constructed from pieces of rigid sheet material that if appropriate are integrally formed or connected together to form the structure discussed above. It is suitable that inter alia the rigid parts of the container are formed from high strength plastics, such as ABS (acrylic butyl styrene) or polycarbonates, carbon fibre composite material or aluminium sheet material, as each offers excellent strength to weight ratios.

Not least because of its use on site in emergency and/or accident situations, it is preferred that the container is electrically non-conductive. High strength plastics, such as ABS (acrylic butyl styrene) or polycarbonates, are preferably used in construction, since these are non-conductive materials

Where the carrier device container is a portable device container, the container is preferably provided with a handle, so that the device may be carried by means of the handle to its site of use.

Suitable and preferred carrying handles are as so described for the portable device for holding sensitive and/or fragile equipment above.

Again, such a handle is displaced or displaceable inwardly of such mountings to be relatively vertically, and preferably as nearly vertically as possible, above the centre or gravity of the fully laden device. This arrangement provides better balance when transported by hand.

Alternatively, the user may wish to keep the (albeit slight) weight of the device container off their hands, e.g. if carrying other equipment, but not incur the extra effort in order to overcome the friction in sliding or dragging it over even a relatively even surface.

Additionally, it is preferred to be able to carry a full kit of resuscitation equipment in a single mobile resuscitation system which can be used in the field, mainly to keep patients alive until proper medical, emergency and/or accident transport is present.

This includes not only a device, with associated pressurised fluid containers such as gas cylinders e.g. for oxygen, and/or gases such as the anaesthetic sold under the trade mark Entonox and Equanox, but also other items of apparatus which may need to be carried by medical and/or emergency and/or accident personnel for use in an emergency and/or accident situation.

These include: dressings, bandages, coverings, such as thermal wraps, and a spare parts and ancillary equipment used in the use of the pressurised fluid containers, such as breathing tubes or airways, a gas driven Venturi suction device, an aspirator jar for receiving material collected by the suction device, a manifold for the foregoing, a manual suction pump to supplement the gas driven suction device, and/or a portable defibrillator.

The overall weight of the system may make it less readily portable, especially over a rough surface in the field in an emergency and/or accident.

Thus, the carrier device or carrier device assembly (capable of holding multiple items of equipment), or a container within which such a carrier device or a carrier device assembly is mounted, may be mounted directly on a towable or pushable structure.

Alternatively it may be mounted indirectly on an external structure (e.g. mounted on a board or panel) in turn mounted on the towable or pushable structure, in both case either permanently connected to, or totally removable from the towable or pushable structure.

Accordingly, an embodiment of the present invention is a carrier device or carrier device assembly, or a container within which such a carrier device or a carrier device assembly is mounted carrier device, characterised in that it is mounted on a mobile structure that is towable or pushable.

Another embodiment of the present invention is a carrier device, characterised in that it is mounted within a towable or pushable structure which is a carrier device container.

The towable or pushable container may be provided with at least one, and preferably at least two, preferably lightweight, rolling means, and preferably one pair thereof, mounted on or in the junction of the rear wall and the base plate. Suitable rolling means include one or two (preferably one) pairs of rollers or wheels.

In one version of this embodiment, the container is intended for medical and/or emergency and/or accident purposes, but in circumstances where, e.g. part or all of the route from an emergency and/or accident or first store and/or transport station to a use location may be over relatively easy terrain, such as the floor of a catwalk, corridor, passageway or walkway, without rough dragging.

The rolling means may be installed in a permanent position, and may extend beyond the container by whatever degree is required and convenient in the operation of this embodiment.

However, the container may be intended for medical and/or emergency and/or accident purposes, in circumstances where, e.g. part of the route to a use location may be over relatively easy terrain, but part involves it being dragged over a rough surface to any great degree.

The rolling means should not then hamper the movement and manoeuvring to and from the patient in a range of trying environments.

Thus, it is then preferred that any such rolling means do not extend beyond the container by too great a degree, or that they be retractable into the container. Such rolling means may be installed in a permanent position, in which case they may be recessed into the carrier container. They may e.g. be housed in complementary recesses in the carrier container, and turning on axles or spindles that span the recesses into the carrier container, such that the carrier container can be still be readily dragged over a rough surface.

Suitable rolling means include one or two (preferably one) pairs of rollers or wheels. These may be mounted on or in one or both of the rear wall or base of the carrier container, the junction of which may be rounded substantially concentrically with the rolling means, and often towards opposite ends of the junction of the rear wall and the base plate.

Alternatively, the rolling means, e.g. one or two (preferably one) pairs of rollers or wheels may mounted to turn on axles or spindles on arms that may be pivotally and/or slidably and/or retractably mounted on, e.g. the rear wall. Then, when the arms are in their rest position, the rolling means are, e.g. housed in complementary recesses in the carrier container. Each may be locked in its use and stored positions.

The arms when required, can be rotated or slid to a use position outwardly, e.g. of the rear wall or the base plate of the container, optionally with a cooperating spring bias and/or damping.

They may them be returned to the rest position when the container needs to be dragged over a rough surface, or when in use on a patient requiring pressurised fluid containers.

Where the arms are slidingly retractable, the mounting means may comprise friction sliding sleeves housing the arms to govern lateral sliding of the arms to extend them outwardly of the container.

When the container is being rolled and manoeuvred on the land and/or over a rough surface or difficult terrain over earth or soil that may be anything from damp to sodden, the earth or soil will tend to attach and stick to the rolling means.

This may occur to such an extent that the rolling means cannot function and seize up and stop working and hamper the movement and manoeuvring of the container.

To avoid this, the container should desirably be provided with (usually) one chisel blade in close proximity to the rolling surface (usually at its top) of the rolling means to plane off the damp to sodden earth or soil.

In use, to assist one handed towing, the container may be towed or pushed on its rolling means by a handle.

The container is in a lower position than when being carried, i.e. rolling on the ground, so that such a handle must be longer than the single carrier handle on an upper part of the carrier device described above.

A single such handle on an upper part of the container is preferred, e.g. at or near the upper end of the rear wall. This may be a straight or U-bar, rod or tube, which may be fixed telescopic towing handle.

It may be advantageous to preserve the streamlining of the device that the container is provided with (usually) one extendable and retractable and/or removable handle, e.g. one slidably mounted on the container or a fixed telescopic tubular handle. Each may be held in its extended use position by sliding friction between the telescopic sleeves, and/or locked by a clamp screw. In either case, it is preferred that it is mounted on an inner face of the container. The towing handle may be a separate integer from the carrying handle described above, or they may be one and the same.

When treating a person using these containers of the present invention it may be desirable to use equipment that requires to be higher than the carrier container e.g. equipment that requires a pressure head to operate, such as a parenteral drip, e.g. infusion bags such as drips. To assist this, the present invention preferably is further provided with a support arm.

This may be a separate integer, or the handle may be used as a drip support arm in the operation of the device, and is then conveniently provided at or towards its top end with one or more hooks, such that infusion bags such as drips can be hung from them.

The position of the hooks may be adjustable to allow infusion bags such as drips can be hung from the hook(s) relatively vertically above the centre or gravity of the fully laden container in use. To provide better balance when in use, it or they is/are preferably as nearly vertically as possible thereabove.

Yet another embodiment of the present invention is a carrier device, characterised in that it is mounted within a carrier device container, which is in turn mounted on a towable or pushable structure.

The towable or pushable structure may be provided with at least one, and preferably at least two, lightweight rolling means, e.g. a roller or wheel, for ready movement during transport and use.

In this embodiment, the towable or pushable structure is intended for medical and/or emergency and/or accident purposes, but in circumstances where, e.g. part or all of the route from an emergency and/or accident or first store and/or transport station to a use location may be over relatively easy terrain, as above.

The rolling means may thus be installed in a permanent position, and may extend beyond the container by whatever degree is required and convenient in the operation of this embodiment. In general, however, the structure in use should desirably be compact with little or nothing projecting that will snag on the environment in the field.

As described further below, it may be desired that the container still be used for medical and/or emergency and/or accident purposes, manoeuvring it to and from the patient in a range of trying environments in rough conditions of use.

It may then be preferred that the container is securely fastened to the structure in a use position, but is readily removable when necessary. The equipment remains protected from damage throughout.

The towable or pushable structure may take a variety of forms dependent on the container to which the structure is to be attached, and the desired permanence or otherwise of the attachment.

The rolling means often include one or two (preferably one) pairs of rollers or wheels. Thus, the structure may, for example be a trolley. Such a trolley often comprises

a generally quadrilateral, parallelogram or rectangular bodywork, preferably a skeleton bodywork, with
(preferably a number of) apertures, cut outs, gaps, openings or windows between
connected or mutually integral stout rigid members of the structure, such as bars, rods, rails or rungs, which may be tubular,
which form a generally flat framework, such as a chassis or scaffold, on which the carrier device container may be mounted, usually by its rear wall.

The framework may often be a chassis or scaffold formed by and comprising one or more pairs of longitudinal members, one of which forms its side, and one or more transverse members mounted on or integral with suitable parts between the ends of the longitudinal members, to span them, of which a pair forms the ends of the framework.

The apertures between the members lessen the overall weight, and this is important in context given the way the device will be used. Additionally, it is preferred that the members of the framework are lightweight, for the same reason, and may thus be made of duralumin or mild steel tubular rod, as each offer excellent strength to weight ratios.

The framework may be used in an upright fashion, and its bottom end may then be provided with a transverse footplate, mounted on or integral with the framework, and projecting at an angle, often at right angles, to the overall framework, on the side on which the carrier device container is to be mounted, to support the base of the container.

The container may be configured to be demountable but locked in a use position, or less preferably fixedly mounted, on the structure, e.g. often with its rear wall running generally along and mounted on a trolley framework.

The latter may be a chassis or scaffold, as described above, comprising one or more pairs of longitudinal members, one of which forms its side, and one or more pairs of transverse members mounted on or integral with suitable parts of the ends of the longitudinal members, to span them.

In such case the container may be mounted in position on two or more permanent or demountable transverse members.

The means to permit attachment of the container will usually have a number of locations at the respective top and bottom of the rear face of the container.

If configured to be demountable but locked in a use position, it may be mounted on the framework, by conventional means, e.g. by mushroom pegs on the container or structure, which engage in respective keyhole slots formed in the structure or container, as appropriate, of the carrier device; or by short threaded set-pins on the structure or container with quick-release, e.g. half-turn butterfly, nuts that engage holes or slots in the other integer.

Alternatively, it may be preferred that the container may be mounted on two or more transverse members, configured to engage, and be mounted as rungs between the longitudinal members of framework. This may be achieved by conventional means, e.g. spring biased pins at each end of the two or more transverse members, which engage in respective holes or slots formed in the longitudinal members which forms the sides of the framework (or vice versa) and which latch or lock to hold them in position.

Alternatively, it may be desired that the container is installed in a permanent position on the framework.

The rolling means often include one or two (preferably one) pairs of rollers or wheels. Often, one such pair is mounted on the bottom end of the framework, or at the junction of the bottom end and transverse footplate, if present. Such rolling means are usually installed in a permanent position. Alternatively, it may be preferred that the framework can be used as a sledge or travois on which the carrier device container may be readily dragged over a rough surface.

The rolling means may then be configured to be demountable but locked in a use position, usually at the bottom end of the framework, or at the junction of the bottom end and transverse footplate, if present. Either may be rounded substantially concentrically with the rolling means.

Alternatively again, the rolling means, e.g. one or two (preferably one) pairs of rollers or wheels, may be retractably mounted, e.g. pivoted and/or slidably mounted at the bottom end of the framework, or at the junction of the bottom end and transverse footplate, if present. Again, either may be rounded substantially concentrically with the rolling means.

Then, when not in use, the rolling means are, e.g. housed alongside or in complementary recesses in the framework on which the carrier device container is mounted, but when required, can be rotated or slid to a use position, optionally with a cooperating spring bias and/or damping.

Where the arms are slidingly retractable, the mounting means may comprise friction sliding sleeves housing the arms to govern lateral sliding of the arms to extend them outwardly of the container.

They may them be returned to the rest position when the framework needs to be dragged over a rough surface, or when in use on a patient requiring pressurised fluid containers.

When the trolley is being rolled and manoeuvred on the land and/or over a rough surface or difficult terrain over earth or soil that may be anything from damp to sodden, the earth or soil will tend to attach and stick to the rolling means, sometimes to such an extent that the rolling means cannot function and seize up and stop working and hamper the movement and manoeuvring of the trolley. To avoid this, the container should desirably be provided with (usually) one chisel blade in close proximity to the rolling surface (usually at its top) of each rolling means to plane off the damp to sodden earth or soil.

In use, the trolley may be towed or pushed on its rolling means by a handle. The container is in a lower position than when being carried, i.e. rolling on the ground, so that such a handle must be longer than the single carrier handle on an upper part of the carrier device described above.

A single such handle on an upper part of the trolley is preferred, e.g. at or near the upper end of the framework. This may be a straight or U-bar, rod or tube, which may be a fixed towing handle.

It may be advantageous to preserve the streamlining of the device that the trolley is provided with (usually) one extendable and retractable and/or removable handle, e.g. one slidably mounted on the trolley or the container or a fixed telescopic tubular handle on either.

The towing handle may thus be a separate integer from the container handle described above, or they may be one and the same. However, it is preferred that it is mounted on the trolley and not the container.

Any such handle may be held in its extended use position by sliding friction between the telescopic sleeves, and/or locked by a clamp screw.

Preferably, members of the structure, such as bars, rods, rails or rungs, which may be tubular, and which form a generally flat framework, such as a chassis or scaffold, and are lightweight, and e.g. may thus be made of duralumin or mild steel tubular rod.

The framework may be a chassis or scaffold, as described above, comprising: one or more pairs of longitudinal members, one of which forms its side, and one or more transverse members mounted on or integral with suitable parts between the ends of the longitudinal members, to span them, of which a pair forms the ends of the framework.

Such a trolley is preferably provided with (usually) one extendable and retractable and/or removable handle that is a telescopic tubular handle that is an integral upper part of the generally flat framework. Thus, a single such handle may be a U-bar, rod or tube, which is mounted to slide telescopically with each end in a pair of longitudinal tubular members, which forms the sides of the framework, the transverse part of the U spanning them to form the to ends of the framework.

When treating a person using the structure of the present invention it may be desirable to use equipment that requires to be higher than the carrier container e.g. equipment that requires a pressure head to operate, such as a parenteral drip, e.g. infusion bags such as drips. To assist this, the present invention preferably is further provided with a support arm.

This may be a separate integer, or the handle may be used as a drip support arm in the operation of the device, and is then conveniently provided at or towards its top end with one or more hooks, such that infusion bags such as drips can be hung from them.

The position of the hooks may be adjustable to allow infusion bags such as drips can be hung from the hook(s) relatively vertically above the centre or gravity of the fully laden trolley in use. To provide better balance when in use, it or they is/are preferably as nearly vertically as possible thereabove.

Other integers for various purposes may be mounted on or in the container, whether it is stand alone or itself mounted on a mobile structure.

Thus, one or more movable trays may be present in or on any of the rear or sides of the device. These are convenient in the operation of the first embodiment to provide a work surface when required. Such a tray may, e.g. be used for receiving ancillary materials and devices used in the use of the pressurised fluid containers.

Usually, such trays are mounted in or on or form part of at least one of the front, rear or side walls of the carrier container. Alternatively (or additionally), such trays may be mounted on two side walls to span the front or rear wall, or on the rear and front wall to span a side wall.

Usually, only one such tray is mounted on one of the front, rear or side walls of the carrier container. Often, one such tray is mounted on the side or rear wall of the carrier container.

The trays may be sliding and/or folding trays that are stored within or against the relevant wall and may be deployed to provide a work surface when required. Such a tray might, when not in use, form part of the protective structure of the carrier container.

Such trays may be arranged to be dropped down or raised up and retained horizontally, either inwardly or outwardly of the carrier device. To provide a more compact device for transporting by hand, it is preferred that the or each tray if more than one are present are constructed to be dropped down or raised up and retained horizontally, outwardly of the carrier device.

Any of such trays may be flip-up trays, which at rest are normally folded down parallel to or in the plane of the relevant wall, but when required, can be rotated up to a use position, usually perpendicular to the relevant wall. If the tray is a flip-up tray, it must be so arranged that when raised up, it is retained horizontally against gravity in some way.

The arms when extended may self-support automatically, using known mechanical mechanisms of a repeat-ratchet kind or a known form of “over-centre” mechanism. Flip-up trays may also be provided with spring bias against gravity and/or damping and a spring latch to hold them in a retracted position.

Alternatively, any of such trays may be flip-down trays, which at rest are normally folded up parallel to or in the plane of the relevant wall, but when required, can be rotated down to a use position, usually perpendicular to the relevant wall.

If the tray is a flip-down tray, it may be so arranged that when dropped down, it is retained horizontally under gravity in abutment with part of the relevant wall, optionally with a, e.g. spring latch.

Where any tray that is provided is a folding tray, it is normally mounted in such a way that it may be readily rotated into its use position. The mounting means may comprise hinging, pivoting, sliding or retractable arms that are configured so as to cooperate with hinges, pivots, axles or in or on a suitable part of the external surface of the rear wall and/or one or both side walls

Where any tray that is provided is a sliding or retractable tray, it is normally mounted in such a way that it may be readily slid into its use position. The mounting means may comprise friction sliding sleeves housing the arms of a tray such that lateral sliding of the arms would extend them outwardly, e.g. of the rear wall of the device.

Other integers for various purposes may be mounted on or in the container, whether it is stand alone or itself mounted on a mobile structure. These include one or two (preferably one) further carrier containers which are mounted on the first carrier container.

These modular extensions may be used as extra storage compartments to house dressings, bandages, coverings, such as thermal wraps, and a pressurised fluid container, such as a gas cylinder, e.g. for oxygen, and/or gases such as the anaesthetic sold under the trade mark Entonox and Equanox.

They may also be used for spare parts and ancillary equipment used in the use of the pressurised fluid containers, such as breathing tubes or airways, a gas driven suction Venturi device, an aspirator jar for receiving material collected by the suction device, a manifold for the foregoing, a manual suction pump to supplement the gas driven suction device, and/or a portable defibrillator.

Such a container is known as a dressings box herein, without in any way limiting its purpose.

Such further containers which are mounted on the first carrier container will usually comprises a generally cuboidal box with a base having an integral upstanding rear wall and side walls and a front wall, defining a rigid enclosure that is enclosed on five sides with an open top.

Each further container may also have a lid which fits over the open top and further protect the contents during transit. Such a lid may be of a complementary shape to the carrier container and may slide thereover, or be hinged or pivoted to rotate to a closure position, and be held by appropriate catch mechanisms.

They may be mounted on any convenient position on the first carrier container, and may be connected thereto by any suitable means. Usually, such further carrier containers are mounted on at least one of the front or side walls of the container, leaving the rear free.

If the rear is provided with a substantially flat face or a junction of the rear wall and the base plate, which may be rounded to serve as a better surface for sliding, on which the container as a whole can be dragged, rolling means, e.g. rollers or wheels for ready movement during transport and use, or is attachment means to permit attachment of the container to an appropriate external structure, then it may be desired to leave the rear wall free.

The front or both side walls of the first carrier container may then be used to mount further carrier containers on the first carrier container.

To provide better balance when transported, two further containers should be mounted, one on each side wall, that are preferably as nearly equal in weight and lading as possible.

Alternatively, the second container may be mounted directly on the top end of the carrier container or the trolley framework above the dressings box, or on the top of the dressings box. It may be used to store a gas driven suction device, a suction jar for receiving material collected by the suction device, a manifold for the foregoing, a manual suction pump to supplement the gas driven suction device, and/or a portable defibrillator. Such further containers will usually comprises a generally cuboidal box with a base having an integral upstanding rear wall and side walls and a front wall with a closed top, defining a rigid enclosure that is enclosed on five sides.

The relevant, e.g. front walls of the carrier container are provided with means to permit attachment of such further modules. These include so-called mushroom pegs and keyhole slots formed respectively on and in the wall of either of the containers.

If more robust attachment to the first carrier device is required, the slots may be provided with clips or latches to retain the heads of the mushroom pegs in the slots in the wall of the device or the component.

Alternatively, the means to permit attachment may be annularly-grooved pegs on either the component or the wall of the device, which extend through holes formed in the wall of either container, and are retained with clips fitting into the groove in the pegs, or rubberized spherical pop fasteners on one, which are a pop fit in holes formed in the wall of the other container, and are retained by resilient re-expansion.

Any of these may be used in combination with a laterally sliding dovetail tenon extending into and engaging with a cooperating V-cleft respectively on either container.

At least a part of the front wall of the further carrier device may also be a panel which forms a closure to the front face, and may be pivotally and/or slidably mounted on the rest of it in such a way that it may be readily rotated into its use position to form a (preferred) flip-down tray or a flip-up tray, for holding the equipment in use from the further carrier container, known as a dressings box.

If the tray is a flip-down tray, it may be so arranged that when dropped down, it is retained horizontally under gravity in abutment with part of a relevant wall, optionally with a, e.g. spring latch.

If the tray is a flip-up tray, it must be so arranged that when raised up, it is retained horizontally against gravity in some way.

For example, when extended it may self-support automatically, using known mechanical mechanisms of a repeat-ratchet kind or a known form of “over-centre” mechanism. Flip-up trays may also be provided with spring bias against gravity and/or damping and a spring latch to hold them in a retracted position.

The present container or towable or pushable structure is in most occasions very stable when placed upright on a surface, but if the surface is uneven or if the centre of gravity of the whole device has been raised, for example by using an extendable drip support arm (described above), it may be advantageous to enhance the stability.

Therefore the present container or towable or pushable structure may be further provided with one or more stabilising means to allow the carrier device or structure resting on its base to be supported on a horizontal integer, such as the ground, a floor or a base plate. Such means may take a variety of forms dependent on the particular features of the carrier container or structure to which the means is to be attached.

When a mobile structure is towable or pushable, such as a trolley, its bottom end may be provided with a transverse footplate, mounted on or integral with the framework, and projecting at an angle, often at right angles, to the framework, on the side on which the carrier device container is to be mounted, to support it.

The rear of the footplate will be raised by the rolling means that are usually installed at the bottom of the trolley framework.

The underside of the footplate may be provided with one or more projections, points or ridges such that the footplate can rest on the ground, a floor or a base plate in a generally horizontal fashion. As with other outwardly projecting integers for various purposes, these may be mounted permanently, retractably or removably for replacement in position on the movable structure.

Especially in using the equipment at an emergency and/or accident site, it may be desirable to be able to ensure ready access to the carrier container or in a dressings box which is mounted on the carrier front (e.g. one in which at least a part of the front wall can form a (preferred) flip-down tray or a flip-up tray.

This may be achieved by tilting the carrier container, either onto the junction of the rear wall and the base when the container is stand alone or the rolling means mounted there, or when mounted on a mobile structure, onto e.g. the bottom of the chassis or scaffold and/or the rolling means mounted there.

To support the container or structure in this position may be achieved in a variety of ways.

It is preferred that the rear and/or side walls of the container or mobile structure may be provided e.g. with as appropriate one or two (preferably one) flip-out retractable stabiliser support, such as a leg, prop or strut, which can project rearwardly at an angle to the container or trolley framework on its rear side (i.e. opposite to that on which the carrier device container is to be mounted).

This is to support the container or mobile structure, such as a trolley, such that it is safe to work on or with the tilted container or structure, e.g. trolley, especially in hazardous situations, such as accidents.

Such a retractable support may be pivoted on mounting means, e.g. brackets or trunnions on one of the pairs of transverse members between the middle and the top end of the container or trolley framework on its rear side.

The mounting means should be configured and adapted to be latched or locked to hold the support in its rest and use positions. For example, a support may have a latching projection cooperating with a notch preventing its further rotation on a member mounted on a surface of the rear wall and/or a side wall, or a clamp screw. The support(s) may also be configured to be demountable.

The container or structure for holding sensitive equipment, such as pressurised fluid containers, may also be provided with a light or lights. The purpose of the light will govern the details of how they are incorporated, but it is currently preferred that at least part of the handle is formed of translucent material and that a light is provided within the handle to shine out of it.

Such a handle light could be directed generally downwards to illuminate the functional cylinder of the container or structure for holding sensitive equipment, such as pressurised fluid containers.

Also a flashing or signalling light such as a strobe may be provided, especially if the container or structure is at an emergency and/or accident site. A solar panel may also be provided to recharge a battery powering the light or lights.

These lights might store and/or transport in the location of the container or structure in the dark or obscured visibility conditions. A signalling light can be connected to the base or to an extension support connected to the base or the rear or a side wall.

This latter may be an integer which is also a towing handle and/or a support for the container or structure for holding sensitive equipment, such as pressurised fluid containers, in use—see below.

The container or structure for holding sensitive equipment, such as pressurised fluid containers, might also be destined for use in water. To assist in its support it may be further provided with an inflatable buoyancy device to support it for use in water. The buoyancy device may be normally stored in a deflated state, but may be inflated on manual activation of a switch or automatically activated on contact with water.

It may be preferred that the carrier container or structure is further provided with attachment means to allow the carrier container or structure to be supported on an external structure.

Such attachment means may take a variety of forms dependent on the item to which the container or structure is to be attached, and the desired security/strength of that attachment.

For example it might be mounted at an emergency and/or accident on a ladder, or on part of a crash trolley or elsewhere on the side of a bed, in such a way that it may be readily accessible and then removed and carried to a use location as needed.

The attachment means may comprise one or more arms shaped such that it or they will locate around a generally horizontal member of the external structure. This may be a railing, the rung of a ladder, part of a crash trolley or the side of a bed, or a support bar or rail on an external structure, such as a wall, and the container or structure will hang therefrom. Usually, such an arm or arms are mounted in or on or form part of the rear of the carrier container or structure.

The arm or arms may be preferably fixedly mounted on the container or structure, e.g. often on a trolley framework in position on one or more transverse members.

Alternatively (or additionally), such arms may be hinging, pivoting, sliding or retractable arms, usually as a pair, that are configured to locate over a suitable part of the external structure when hinged, pivoted or extended outwardly from their non-use position.

They are usually mounted in the same position as fixed arms on the rear of the container or structure, e.g. often on a trolley framework in position on one or more transverse members.

The means may comprise any number or such arms, or pairs of such arms, which may be mounted on or in and/or extend across the rear of the carrier container or structure. The means may comprise a single arm, which may be mounted on or in or span the rear of the carrier container or structure. This will usually be elongate across the rear, and shaped such that they will locate around a generally horizontal member of an external structure. For example, the arm may partly or completely transversely span the external face of the rear of the carrier container or structure. Often, one pair of arms is mounted on the rear of the carrier container or structure.

The arm or arms are often towards the top end of carrier container or structure, so that when hooked over an external structure, the rear rests against and is supported by part of the external structure over which it is located.

Where there is not a member of the external structure to do this, it may be desired for security of the attachment that the attachment means comprises two pairs of arms, one towards the top end of the rear of the carrier container or structure, and the other towards the base.

Features of flip-up arms or flip-down arms are as described above for movable trays in or on any of the rear or sides of the container or structure.

When the need for accident or emergency treatment involving sensitive equipment, such as pressurised fluid containers, is realised, the container or structure as a whole may be carried or wheeled using a handle to its site of use. Once the site of use has been reached, the container or structure is manoeuvred into close proximity with the person requiring treatment. This may involve difficult manoeuvring such as through an emergency and/or accident site, such as a wrecked car, industrial plant or air or sea transportation. In such circumstances, its sturdy protective design, described above, is advantageous.

Once in close proximity to the person requiring treatment, the medical and/or emergency and/or accident personnel can use the remove the apparatus in the carrier or structure therefrom as necessary. Once used, the component parts that have been removed may be put back into the carrier container or structure and it may then be manoeuvred away from the patient.

Another intended purpose of the device for holding sensitive and/or fragile equipment, such as pressurised fluid containers, is in non-emergency domestic and/or hospital situations, where it is not required to manoeuvre the device into difficult confined spaces.

There is then less need to have no features that will snag on the environment, or otherwise hamper the movement and manoeuvring of the device to and from the patient, or to have a substantially flat face broader than it is deep on which the contained device or carrier device assembly can be more stably dragged e.g. by a single handle on an upper part of the container, as described above, during such manoeuvring.

It may still however be necessary that it be portable or towable or pushable, whilst being safe and easily moved by an individual, be left resting on a base plate supported on a floor, e.g. by the side of a bed.

It will be left in such a way that it may be readily accessible and then removed and carried to another use location as needed.

In its simplest form, an embodiment of the present invention is a carrier device, characterised in that it is mounted on a fixed upright integer, such as a panel, or wall, by its first jaw which runs generally along the mounting surface.

The panel or wall in turn is mounted on a generally horizontal integer, such as a base plate or stand, to extend upwardly of the generally horizontal integer, e.g. at right angles to the overall assembly.

Although such a device may be configured to locate over, span and hold multiple items of equipment, i.e. it is a carrier device assembly comprising at least two cradles for holding equipment, mounted side by side, it is particularly useful in situations where the device is to be used for holding one item of equipment, and urge it into one cradle.

In either case, the second jaw and cover may be no more than a framework formed by and comprising:

one pair of longitudinal members, each of which forms its side, and each being pivotally mounted on a pair of arms, running mutually parallel between the two jaws, respectively towards or at the top end and bottom end of the device, and one or more (usually one) transverse arms, e.g. a rigid bar, pole, rail, or rod or a generally flat plate, pivotally mounted, respectively towards or at the top end and bottom end (usually the top end) of one of the longitudinal members, and configured and adapted to span across to, and be latched or locked to hold them or it on the other.

For example, an arm may have a notches cooperating with a projection on the other.

Such an arrangement provides better access to the equipment than is permitted by a more enclosed cover.

It may still be desirable that it should be streamlined, and therefore to enclose a carrier device or a carrier device assembly (capable of holding multiple items of equipment) by a container, such as a box, casing or sheath, or other covering, optionally with a lid which fits over the open top.

Such a container may be of a complementary shape to the carrier device or carrier device assembly and may slide thereover, provided that the device or carrier device assembly can still rotate to and from a closure position within it. Often the container comprises a generally cuboidal box with a base having an integral upstanding rear wall and side walls and a front wall, defining a rigid and optionally partly open-fronted enclosure that is enclosed on five sides. The front wall may extend over any proportion or all of the front face. Alternatively, the container may be cylindrical.

The carrier device or carrier device assembly may often be mounted directly or indirectly (e.g. mounted on a board or panel in turn mounted) on the rear wall, or less often on one of the side walls, of the carrier container.

Although such a container may be configured to locate over, span and hold multiple items of equipment, i.e. it is a carrier device assembly comprising at least two cradles for holding equipment, mounted side by side, it is particularly useful in situations where the device is to be used for holding one item of equipment, and urge it into one cradle. Such a generally cuboidal box container may then have a square, rather than an oblong base, for the reasons given above.

Such a device or container for holding sensitive equipment, such as pressurised fluid containers, in accordance with this invention is particularly useful in situations where the device is to be used for holding one item of equipment, resting on its base supported on a floor, e.g. by the side of a bed. It holds it in such a way that it may be readily accessible and then removed and carried to another use location as needed.

The present device or container is in most occasions very stable when placed upright on a surface, but if the surface is uneven, as the centre of gravity of the whole is relatively high above a relatively narrow base plate, the present device or container may be further provided with two or more stabilising means to allow the carrier device or container resting on its base to be supported stably on a floor.

Such means may take a variety of forms dependent on the particular features of the carrier device or container to which the means is to be attached.

It is preferred that the base plate or base be provided e.g. with as appropriate two or three (preferably three) elongate flip-out retractable stabiliser supports, such as arms or feet, which can project outwardly from the device or container in different directions, e.g. at 60°, to one another, along the floor, e.g. by the side of a bed, on which the device or container is resting.

Alternatively, two or three (preferably three) elongate flip-out retractable stabiliser supports, such as legs, props or struts, may be pivotally mounted on rear and/or side walls of the device.

These can project outwardly from the container in different directions, e.g. at 60°, to one another, along the floor, e.g. by the side of a bed, on which the container is resting,

Any such retractable support may be pivoted on mounting means, e.g. brackets or trunnions on the relevant part of the device or container. The mounting means should be configured and adapted to be latched or locked to hold the support in its rest and use positions. The support(s) may also be configured to be demountable.

The base plate or base may be provided e.g. with as appropriate two or three (preferably three) elongate flip-out retractable stabiliser supports, such as arms or feet, which can project outwardly from the device or container.

In such case, each support may be pivotally mounted on a follower which can move around an annular member mounted on the underside of the base plate.

The base plate may then be provided with three or more projections, points or ridges such that the base plate is held clear of the ground. In this way, the angle between the retractable stabiliser supports is adjustable as may be convenient.

It may be necessary to leave heavy pressurised fluid containers, such as a gas cylinder, e.g. for medical gases such as oxygen or gases such as the anaesthetic sold under the trade mark Entonox and Equanox, for use in non-emergency domestic situations, where it is required to manoeuvre around the patient in relatively confined spaces, e.g. by the side of a bed, resting on its base supported on a floor. Thus there should be no features that prevent safe and easy movement by an individual carrier about the patient.

There is then less space for the type of freestanding device or container described hereinbefore. That is, a carrier device with the (“static’) jaw of the device mounted in upright fashion on a relatively narrow base plate, with, e.g. a gas cylinder, e.g. for medical gases such as oxygen or gases such as the anaesthetic sold under the trade mark Entonox and Equanox, held up upright on it, and provided with two or more elongate flip-out retractable stabiliser feet, to allow the carrier device or container resting on its base to be supported stably on a floor.

Such a device or container may be provided with alternative stabilising means to the elongate flip-out retractable stabiliser feet, to allow the carrier device or container resting on its base to be supported stably on a floor. Such means may take a variety of forms, but include an inertia reel strap, as used in car front seat belt or strap, around the gas cylinder, device or container. This holds it safely, but in such a way that it may be readily accessible and then removed and carried to another use location as needed.

In non-emergency domestic and/or hospital situations, where it is not required to manoeuvre the device into difficult confined spaces, it may still however be necessary that it be towable or pushable, to be safely and easily moved by an individual to a use location as needed.

In one form, one or more carrier devices of the present invention or a carrier device assembly, optionally mounted directly or indirectly (e.g. mounted on a board or panel in turn mounted) in a carrier container may advantageously be readily removably mounted on a towable or pushable structure which is a mobile drip support, e.g. on and/or around its central drip support arm.

A carrier device forming a part of a static or portable container or structure for holding sensitive equipment, such as pressurised fluid containers, in accordance with this invention is described and illustrated with reference to the drawings, showing embodiments by way of example only.

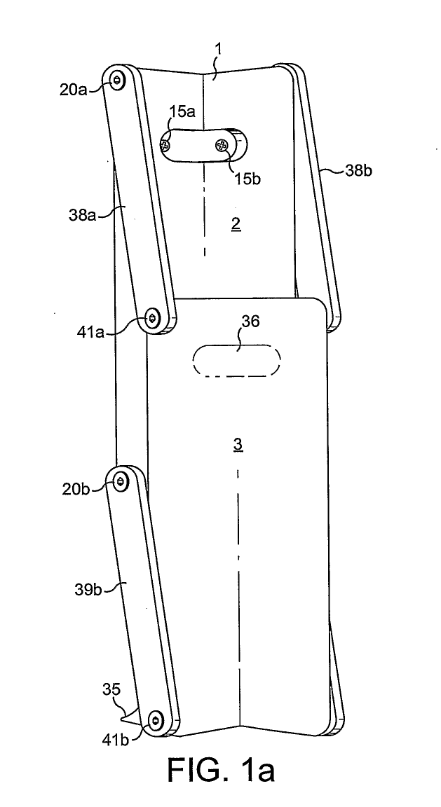

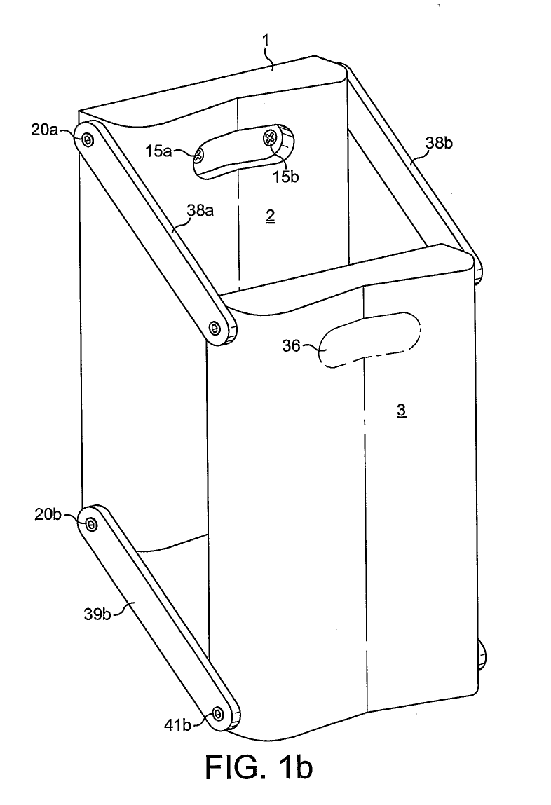

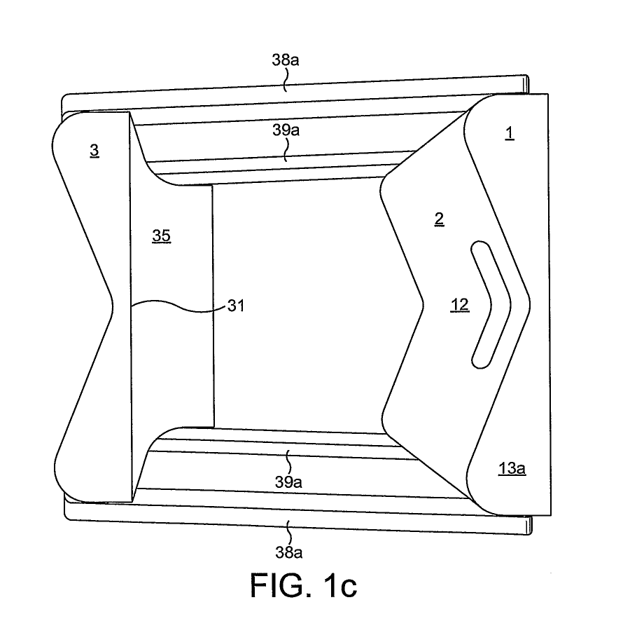

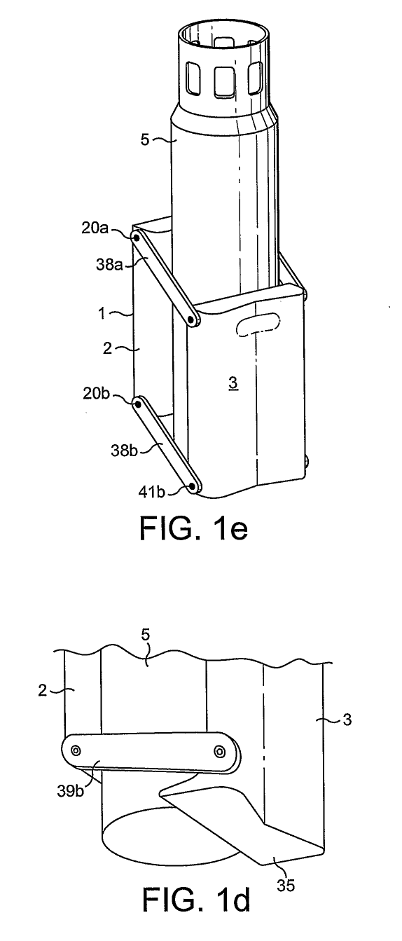

FIGS. 1a, 1b and 1c show respectively

an isometric view of a carrier device at rest,
an isometric view of the carrier device, when raised to a loading position, for the equipment to be held to be loaded between the jaws; and
a top perspective view of the device, when fully raised.

FIG. 1d shows an isometric view of the equipment locating means at the bottom end of the device of FIGS. 1a to d.

FIG. 1e shows an isometric view of a laden device in use, holding a pressurised fluid container.

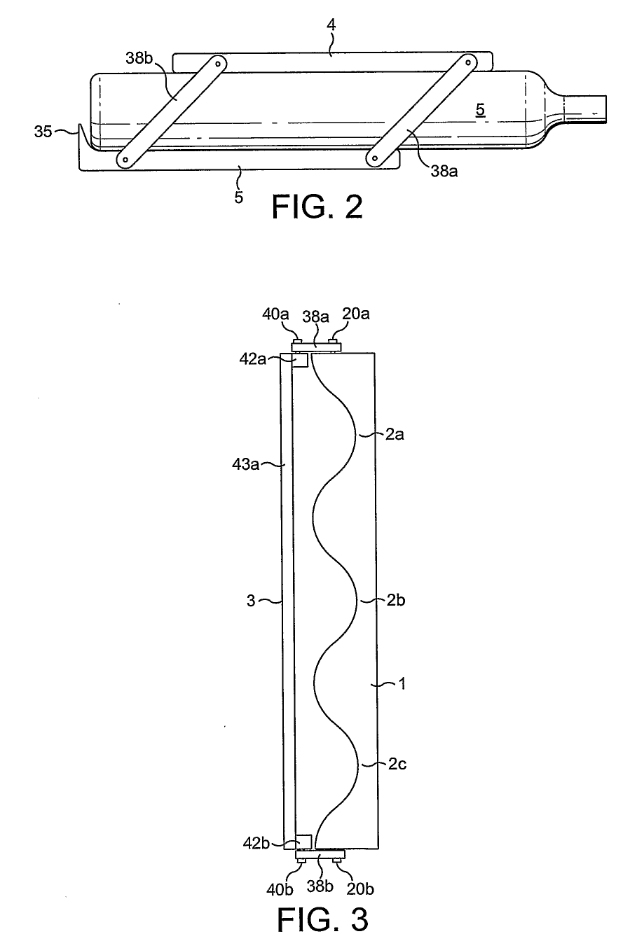

FIG. 2 shows a side view of the laden carrier device, when mounted in lateral suspended fashion, suspended from a generally horizontal integer.

FIG. 3 shows a top plan view of the first jaw and three integrally formed cradles, each holding a gas cylinder, of a carrier device.assembly.

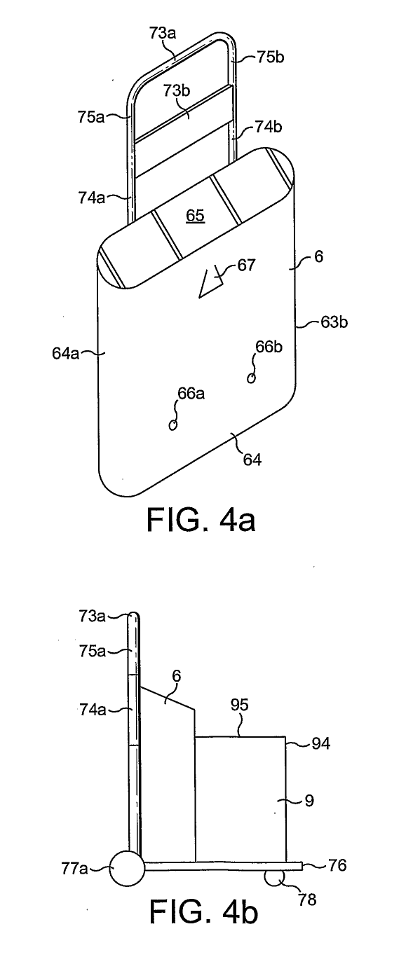

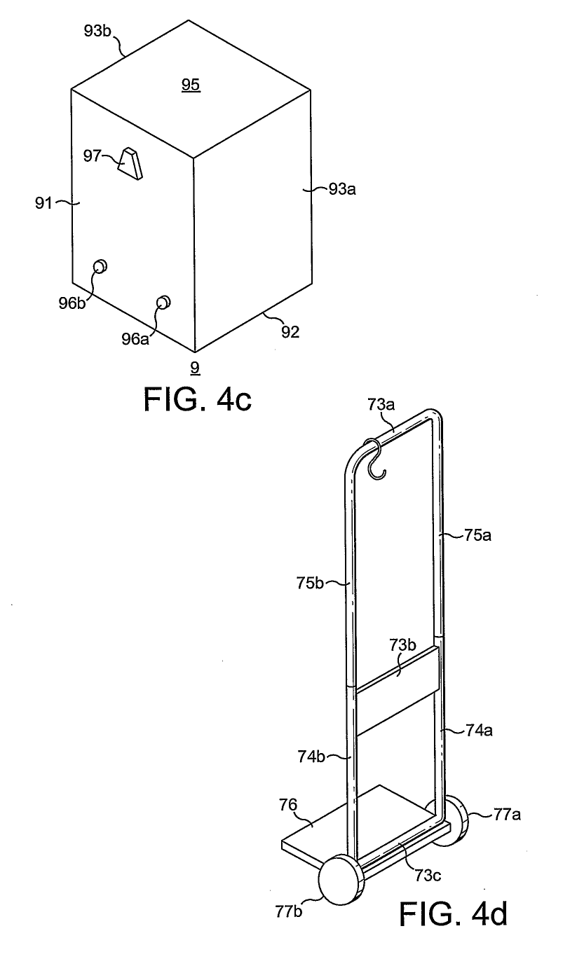

FIG. 4a shows an isometric view of a carrier device container mounted by its rear wall on the framework of a trolley.

FIG. 4b shows a side view of the carrier device container and trolley of FIG. 4a.

FIG. 4c shows an isometric view of the rear wall of a dressings box to be mounted on the front of the container on the trolley in FIG. 4a.

FIG. 4d shows an isometric view of the framework of the trolley of FIG. 4a.

FIG. 4e shows an isometric view of the trolley of FIG. 4a, tilted back in use on its wheels at the junction of the framework bottom end and transverse footplate, and held up by a retractable support

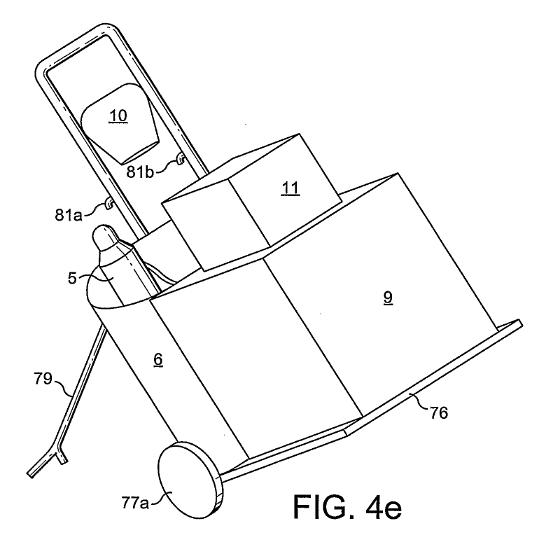

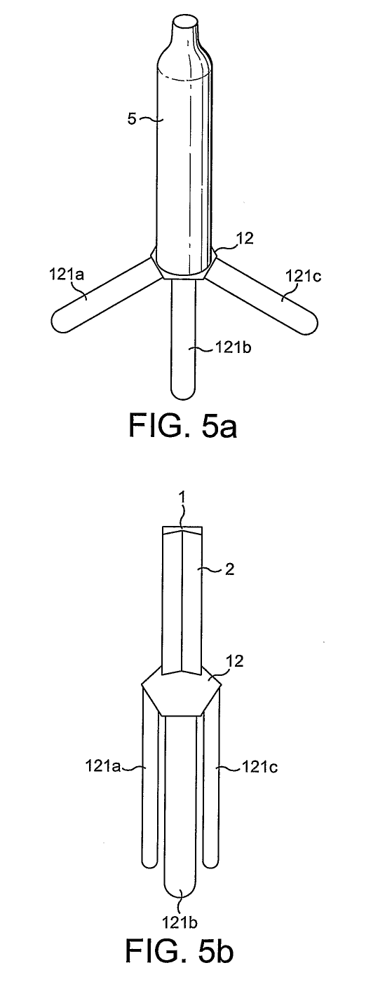

FIG. 5a shows an isometric view of a carrier device mounted on a base plate supported on a floor, e.g. by the side of a bed, with three elongate flip-out retractable stabiliser feet.

FIG. 5b shows an isometric view of a carrier device of FIG. 5a with its three elongate flip-out retractable stabiliser feet out of use.

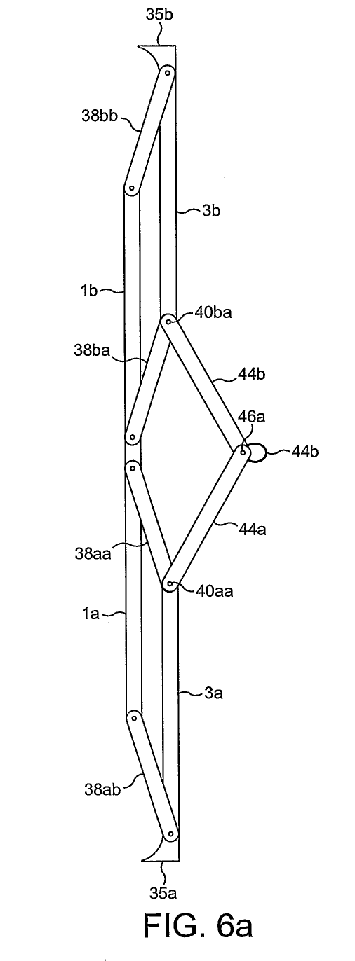

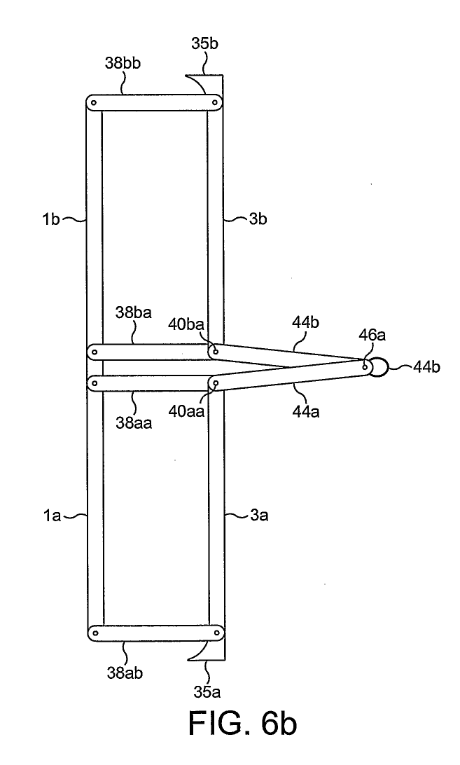

FIGS. 6a and 6b show a side view of a pantograph carrier device assembly, mounted in upright fashion on a wall, respectively at rest, with the jaws closed and in use, with them open.

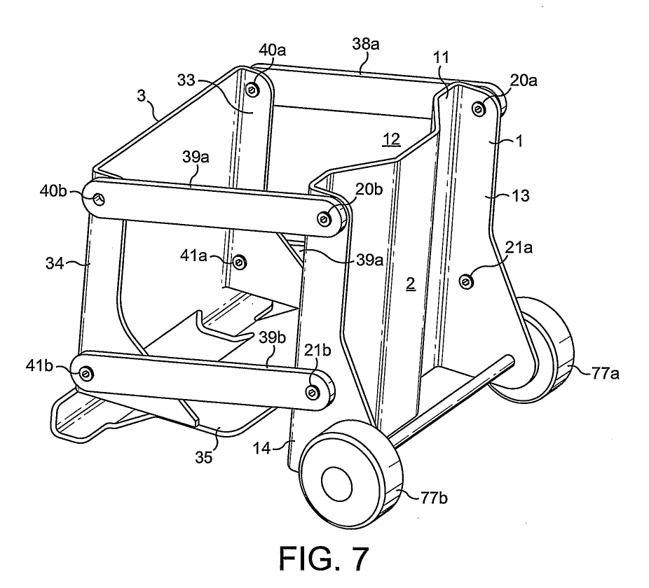

FIG. 7 shows a side isometric view of a towable or pushable carrier device.

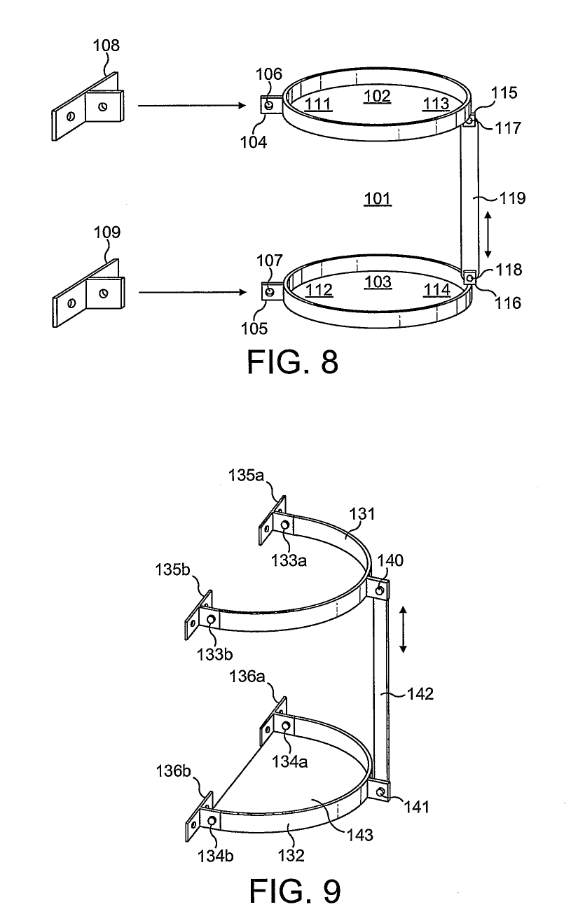

FIG. 8 shows a partially exploded perspective view of a carrier device with a jaw assembly comprising a first jaw integral with a second jaw, when raised to a loading position.

FIG. 9 shows an isometric view of a carrier device where the first jaw is an upright integer on which the second jaw is mounted, when raised to a loading position.

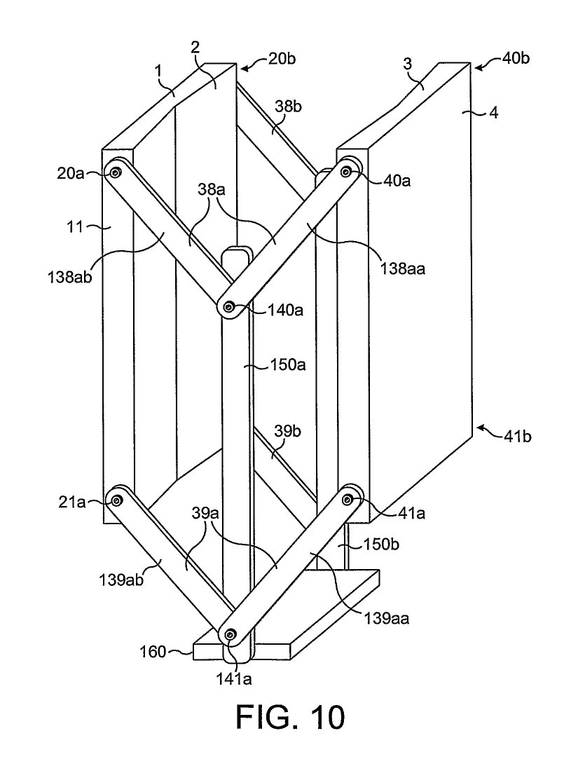

FIG. 10 shows an isometric view of an unladen carrier device, when raised to a normal loaded position, for equipment to be held between the jaws.

Referring to FIGS. 1a to 1d of the drawings, the carrier device comprises a first jaw (1) with a cradle (2) for holding the equipment, and a second jaw (3), movably mounted on the first jaw (1) and configured to locate over and at least partly span the equipment and urge it into the cradle (2).

The first jaw (1) and its component cradle (2) for the equipment and the second jaw (3) and its component cover (4) are elongate in the same direction, and all of these integers are roughly co-extensive.

The first jaw is provided with a base (11) having an integral cradle (2) formed in the base (11) of the jaw (1) by a shallow V-channel (12), and upstanding flange side walls (13a, 13b and 14a, 14b), the whole defining a rigid first jaw (1).

The second jaw (3) comprises an integral cover (4), defined by an integral shallow-V projection (31) and in use cooperating with the cradle (2) to hold an item of equipment, and upstanding flange side walls (33a, 33b and 34) and a locating means, here a foot (35), the whole defining a rigid second jaw (3). A recessed handhold (36) is integrally formed in and towards the top end of the second jaw (3) on its face (37) away from the projection (31).

The second jaw (3) is provided with two pairs of arms (38a, 38b and 39a, 39b).

These are pivoted to rotate on two pairs of pivots (40a, 40b and 41a, 41b) on the second jaw (3), and on two pairs of pivots (20a, 20b and 21a, 21b) on the first jaw (1). One pair of arms (38a, 38b) is mounted towards the top end of the carrier device, and the other (39a, 39b) is mounted towards the bottom end of the carrier device.

The two pairs of arms (38a, 38b and 39a, 39b); all have the same lengths between pivots, so that rotation gives the first (1) and second (3) jaws mutual parallel motion.

The first jaw (1) of the carrier device is mounted in upright fashion on a wall (not shown in FIG. 1) by four screws (15a, 15b and 16a, 16b), respectively one and two of which near the top end of the device are shown in FIGS. 1a and 1b). (The device may alternatively be mounted in inverted fashion (bottom end uppermost) on an upright integer, such as a wall; in lateral laid-down fashion on a generally horizontal integer, such as a floor or a base plate; or in lateral suspended fashion, suspended from a generally horizontal integer, such as a ceiling or lid).

When at rest, as in FIG. 1a, the two pairs of arms (38a, 38b and 39a, 39b) hang down, and the jaws are closed.

In use of the device, the second jaw (3) is lifted by means of the recessed handhold (35), so that the arms (38a, 38b and 39a, 39b), rotate about their pivots (40a, 40b and 41a, 41b) on the second jaw (3), and on two pairs of pivots (20a, 20b and 21a, 21b) on the first jaw (1). Rotation gives the first (1) and second (3) jaws mutual parallel motion and opens them, as shown in FIGS. 1b and 1c.

The equipment, such as a pressurised fluid container, here a lightweight gas cylinder, is then slid in between the jaws (1, 3) of the device to engage the foot (35) projecting inwardly of the second jaw (3) of the device and locate one end of the equipment longitudinally between the jaws, as shown in FIG. 1d.

The recessed handhold (35) is then released, and the arms (38a, 38b and 39a, 39b), drop down under gravity, so that the first (1) and second (3) jaws close on and retain the equipment, here a gas cylinder (5), as shown in FIG. 1e.

The first (1) and second (3) jaws and the arms (38a, 38b and 39a, 39b), together define a partially open-sided enclosure, in which the equipment is protected from damage during storage, but is readily removable when necessary.

Referring to FIG. 2 of the drawings, the carrier device comprises a first jaw (1) for holding the equipment, and a second jaw (3), movably mounted on the first jaw (1) and configured to locate over and at least partly span the equipment and urge it into the cradle (2). The first jaw (1) and the second jaw (3) are elongate in the same direction, and both these integers are roughly co-extensive.

The first jaw is provided with a base (11) having an integral cradle (2) formed in the base (11) of the jaw (1) by a shallow V-channel (12) (not shown), and upstanding flange side walls (only one shown—14a), the whole defining a rigid first jaw (1). The second jaw (3) comprises an integral cover (4), defined by an integral shallow-V projection (31) (not shown) and in use cooperating with the cradle (2) to hold an item of equipment, and upstanding flange side walls (only one shown—33a) and a locating means, here a foot (35).

The whole defines a rigid second jaw (3).

A recessed handhold (36) (not shown) is integrally formed in and towards the top end of the second jaw (3) on its face (37) (not shown) away from the projection (31).

The second jaw (3) is provided with two pairs of arms (only one of each pair shown—38a, 39a), which are pivoted to rotate on two pairs of pivots (only one of each pair shown—40a, 41a) on the second jaw (3), and on two pairs of pivots (only one of each pair shown —20a, 21a) on the first jaw (1).

One pair of arms (38a, 38b) is mounted towards the top end of the carrier device, and the other (39a, 39b) is mounted towards the bottom end of the carrier device. At least one arm is provided at its end near the base (11) or cover (4) with a spring bias, cooperating with the base (11) or cover (4), such that the jaws are urged together.

The jaws (1) and (3) of the device may also be fastened, e.g. latched or locked to hold them in a position to hold the equipment, here a lightweight gas cylinder (5), in place.

The two pairs of arms (38a, 38b and 39a, 39b) all have the same lengths between pivots, so that rotation gives the first (1) and second (3) jaws mutual parallel motion.

The first jaw (1) of the carrier device is mounted in lateral suspended fashion, suspended from a generally horizontal integer, such as a ceiling or lid. (not shown). When at rest, the spring bias, cooperating with the base (11) or cover (4), urges the jaws (1) and (3) together.

In use of the device, the second jaw (3) is pulled down by means of the recessed handhold (35). This causes the arms (38a, 38b and 39a, 39b) to rotate about their pivots (40a, 40b and 41a, 41b) on the second jaw (3), and on two pairs of pivots (20a, 20b and 21a, 21b) on the first jaw (1). Rotation gives the first (1) and second (3) jaws mutual parallel motion and opens them.

The equipment, such as a pressurised fluid container, here a lightweight gas cylinder, is then slid in between the jaws (1, 3) of the device to engage the foot (35) projecting inwardly of the second jaw (3) of the device and locate one end of the equipment longitudinally between the jaws.

The recessed handhold (35) is then released, and the arms (38a, 38b and 39a, 39b), are pulled up by the spring bias, so that the first (1) and second (3) jaws close on and retain the equipment, here a gas cylinder (5).

The first (1) and second (3) jaws and the arms (38a, 38b and 39a, 39b), together define a partially open-sided enclosure, in which the equipment is protected from damage during storage, but is readily removable when necessary.

FIG. 3 shows a top plan view of the first jaw (1) and three integrally formed cradles (2a,2b,2c), each holding a gas cylinder (5a, 5b, 5c), in a carrier device.assembly (rest not shown).

A single second jaw (3) is a framework formed by and comprising one pair of longitudinal members (42a, 42b), each of which forms its sides, and each being pivotally mounted on a pair of arms (38a, 38b and 39a, 39b), which are pivoted to rotate on two pairs of pivots (40a, 40b and 41a, 41b) on the second jaw (3), and on two pairs of pivots (20a, 20b and 21a, 21b) on the first jaw (1).

One pair of arms (38a, 38b) is mounted towards the top end of the carrier device, and the other (39a, 39b) is mounted towards the bottom end of the carrier device.

The two pairs of arms (38a, 38b and 39a, 39b) run mutually parallel between the two jaws, and all have the same lengths between pivots, so that rotation gives the first (1) and second (3) jaws mutual parallel motion.

Two transverse arms, here each a bar (43a, 43b) are mounted, respectively towards the top end and bottom end of the longitudinal members (42a, 42b).

The bar (43b, not shown) that is mounted towards bottom end of the longitudinal members (42a, 42b) is configured and adapted to span across, and be fixedly mounted on them, to hold one to the other. The other bar (43a) is pivotally mounted on the member (42a) and is configured and adapted to span across to, and be latched or locked onto, the other member (42b).

The device assembly is installed permanently in upright fashion on an upright integer (not shown), such as a bulkhead, divider, panel, partition or wall; e.g. in a road vehicle, such as a heavy goods vehicle, such as a lorry, wagon or truck, or van, or in a railway vehicle, such as a wagon or van.

When at rest, the two pairs of arms (38a, 38b and 39a, 39b) hang down, and the jaws are closed.

In use of the device, the bar (43a) is unlatched or unlocked from the member (42b), and pivoted to the other side of the member (42a).

The second jaw (3) is lifted, so that the arms (38a, 38b and 39a, 39b), rotate about their pivots (40a, 40b and 41a, 41b) on the second jaw (3), and on two pairs of pivots (20a, 20b and 21a, 21b) on the first jaw (1). Rotation gives the first (1) and second (3) jaws mutual parallel motion and opens them.

The gas cylinders (5a, 5b and 5c are then slid in between the jaws (1, 3) of the device, to locate one end of the equipment longitudinally between the jaws. The second jaw (3) is then released, and the arms (38a, 38b and 39a, 39b), drop down under gravity.

The bar (43a) is pivoted back to, and latched or locked to the member (42b), so that the first (1) and second (3) jaws close on and retain the equipment.

Such an arrangement provides better access to the equipment than is permitted by a more enclosed cover.

FIG. 4a shows an isometric view of a carrier device container (6) mounted by its rear wall on the framework of a trolley, FIG. 4b shows a side view of the carrier device container and trolley of FIG. 4a, and FIG. 4d shows an isometric view of the framework (71) of the trolley of FIG. 4a.

In FIG. 4d, the trolley (7) comprises a rectangular framework (71) formed by and comprising:

one pair of longitudinal members (72a, 72b) which forms its sides, and
three transverse members (73a, 73b, 73c) mounted on or integral with the longitudinal members, to span them, of which a pair (73a, 73c) forms the ends of the framework (71).

The longitudinal members (72a, 72b) which form the sides, and the two transverse members (73a, 73c) are integral with the longitudinal members (72a, 72b) are made of duralumin or mild steel tubular rod, as each offers excellent strength to weight ratios.

The transverse member (73b) is a generally flat plate, mounted towards the middle of the longitudinal members (72a, 72b) to span them, and to form a mounting for an aspirator jar (10) (not shown), and is usually made of the same materials as the other members.

The longitudinal members (72a, 72b) which form the sides of the framework (71) are telescopic, i.e. they comprise friction sliding sleeves in their lower parts (74a, 74b) housing their upper parts (75a, 75b). The latter, with the transverse member (73a) form a U-tube, which is mounted to slide telescopically with each end in the lower parts (74a, 74b) of the longitudinal tubular members (72a, 72b), and acts as a telescopic tubular handle for towing or pushing the trolley. The telescopic members (72a, 72b) are shown fully extended.

The handle member (73a) is used as a support arm for equipment that requires a pressure head to operate, such as a parenteral drip, e.g. infusion bags such as drips.

To assist this, it is provided with an S-hook (8), such that an infusion bag such as a drip can be hung from it.

The framework (71) is used in an upright fashion, and its bottom end is thus provided with a transverse footplate (76) mounted on the framework (71) and projecting at right angles, to the overall framework (71) on the side on which the carrier device container (6) is to be mounted, to support the base (62) of the container.

A pair of wheels (77a, 77b) is mounted in a permanent position on the bottom end of the framework (71) at the junction of the bottom end and transverse footplate (76).

Alternatively, if it is preferred that the framework can be used as a sledge or travois on which the carrier device container may be readily dragged, the wheels may be demountable in the same position.

In FIG. 4a and FIG. 4b, a carrier device container (6) is mounted on the framework (71) of a trolley (7) (described above in relation to FIG. 4d, which comprises a transverse member (73b), here a generally flat plate.

This is mounted between the longitudinal members (72a, 72b) and the handle member (73a). A transverse footplate (76) mounted on and projecting at right angles to the framework (71) supports the base (62) of the container. The telescopic members (72a, 72b) are shown fully compressed.

The container (6) is a generally cuboidal box with a base having an integral upstanding rear wall (61), side walls (63a, 63b) and a front wall (64), defining a rigid enclosure that is enclosed on five sides.

It is configured and adapted to embrace a carrier device assembly of the present invention (65) which can hold three items of equipment in three integrally formed side by side cradles each holding a gas cylinder, e.g. a gas cylinder, e.g. for medical gases such as oxygen or gases such as the anaesthetic sold under the trade mark Entonox.

The carrier device assembly (65) is mounted directly on the rear wall (61) of the carrier container (6). The container thus has an oblong base (62) so defining a rigid enclosure that is broader than it is deep.

The rear wall (64) of the container (6) is mounted on two or more transverse members (68a, 68b) (not shown), configured to engage, and be mounted as rungs between the longitudinal members (72a, 72b) of the framework (71). This is achieved by a spring biased latch pins in each end of the two or more transverse members, which engage in respective holes or slots formed in the longitudinal members (72a, 72b).

A pair of wheels (77a, 77b) is mounted in a permanent position on the bottom end of the framework (71) at the junction of the bottom end and transverse footplate (76). The rear of the footplate (76) is raised by the wheels (77a, 77b) at the bottom of the trolley framework (71).

The underside of the footplate (76) is provided with several projections (78), here ridges, such that the footplate (76) can rest on the ground, a floor or a base plate in a generally horizontal fashion.

The front wall (64) of the container has two holes (66a, 66b) in its lower part and a V-cleft (67) in its upper part.

These are configured and adapted respectively to engage rubberized spherical pop fasteners (96a, 96b) in a pop fit, and a laterally sliding dovetail tenon (97) mounted and/or formed in the rear wall (91) of a dressings box (9), shown in FIG. 4c, allowing the dressings box (9) to be mounted on the front wall (64) of the container (6) on the trolley (7).

FIG. 4c shows the dressings box (9) referred to above, which is a generally cuboidal box with a base (92) having an integral upstanding rear wall (91) and side walls (93a, 93b) a front wall (94) and a top (95), defining a rigid and optionally partly open-fronted enclosure that is enclosed on six sides.

The front wall (94) of the box (9) is panel which forms a closure to the front face, and is pivotally and slidably mounted on the rest of the box (9), such that it may be readily rotated into its use position to form a flip-down tray for holding the equipment in use from the dressings box (9), or any other further containers.

The flip-down tray is so arranged that when dropped down, it is retained horizontally under gravity in abutment with part of a relevant wall, and has a spring latch to retain it.

As described above, the rear wall (91) of the dressings box (9) container has two rubberized spherical pop fasteners (96a, 96b) in its lower part and laterally sliding dovetail tenon (97) mounted and/or formed in its upper part, configured and adapted respectively to engage in a pop fit with holes (66a, 66b), and a V-cleft (67) in the front wall (64) of the container (6), allowing the dressings box (9) to be mounted on the container (6).

FIG. 4e shows an isometric view of the trolley (7) of FIG. 4a, tilted back in use on its wheels (77a, 77b) at the junction of the framework bottom end and transverse footplate (76), and held up by a retractable support (79). The flip-out retractable stabiliser support (79), here a prop or strut, is pivoted on mounting brackets or trunnions (80) (not shown) on the middle transverse member (73b) in the trolley framework (71) on its rear side.

In use it projects rearwardly at an angle to the trolley framework (71) to support the trolley (7) such that it is safe to work on or with the tilted trolley (7), especially in hazardous situations, such as accidents. The mounting means (80) are configured and adapted to be latched or locked to hold the support in its rest and use positions.

The rear of each of the longitudinal members (72a, 72b) has hook arms (81a, 81b) near the transverse member (73b), enabling the trolley (7) to be attached to a horizontal bar of a trolley, wheel chair or bed, for example. The hook arm (81a) is shown in a fixed position in FIG. 4e, but it may be a retractable arm, pivotally mounted to move outward to the position shown in FIG. 4e.

A box (11) for any of the following: spare parts and ancillary equipment used in the use of the gas cylinders, such as breathing tubes or airways, a gas driven suction device, a manifold for the foregoing, a manual suction pump to supplement the gas driven suction device, and/or a portable defibrillator, is mounted with its base on the top of the container (6).

An aspirator jar (10) for receiving material collected by a suction device is mounted on the transverse member (73b).

Referring to FIGS. 5a and 5bc of the drawings, FIG. 5a shows an isometric view of a carrier device mounted by its elongate first jaw (1) on, to extend upwardly from, a base plate (12) (both obscured by equipment, here a lightweight gas cylinder (5), in place in the carrier device).

Three elongate flip-out retractable stabiliser feet (121a, 121b, 121c) are hinged on the edges of the base plate (12).

A second jaw (3) is pivoted to rotate on the first jaw (1) and spans the cradle (2), formed in the first jaw (1) by a shallow V-channel (12), running mutually parallel to the first jaw (1) and second jaw (3).

The second jaw (3) is omitted from FIGS. 5a, 5b and partly from FIG. 5c for clarity.

FIG. 5b shows the carrier device of FIG. 5a, with the three elongate flip-out retractable stabiliser feet (121a, 121b, 121c) hinged down on the edges of the base plate (12) in a rest position, from which they may be rotated to lie in the use position shown in FIG. 5a, perpendicular to the first jaw.

Each is retained horizontally by being in abutment with part (not shown) of the base plate (12), preventing its further rotation. (Each may alternatively or additionally be held in position e.g. by a spring latch.)

Alternatively, it may be preferred that the stabiliser feet (121a, 121b, 121c) may be hinged up on the edges of the base plate (12) to run generally alongside the device in a rest position, from which they may be rotated to lie in the use position shown in FIG. 5a. In either case the stabiliser feet (121a, 121b, 121c) are latched or locked to hold them in the rest position. Such latches or locks are not shown.

In FIGS. 5a and 5b, a cradle (2) formed in the first jaw (1) by a shallow V-channel (12), running mutually parallel to the first jaw (1) and second jaw (3) provides two-point contact with the equipment.

The second jaw (3) is omitted partly from FIG. 5a and FIG. 5b for clarity.

The second jaw (3) is a framework as described hereinbefore for FIG. 3, comprising one pair of longitudinal members at its sides, and each being pivotally mounted on a pair of arms (38a, 38b and 39a, 39b—only 38a, 38b shown), which are pivoted to rotate on two pairs of pivots (40a, 40b and 41a, 41b) on the second jaw (3), and on two pairs of pivots (20a, 20b and 21a, 21b) on the first jaw (1) (none shown).

One pair of arms (38a, 38b) is mounted towards the top end of the carrier device, and the other (39a, 39b) is mounted towards the bottom end of the carrier device. The two pairs of arms (38a, 38b and 39a, 39b) run mutually parallel between the two jaws, and all have the same lengths between pivots, so that rotation gives the first (1) and second (3) jaws mutual parallel motion.

Two transverse arms, here each a bar (43a, 43b) (omitted) are mounted, respectively towards the top end and bottom end of the longitudinal members (42a, 42b).

The bar (43b) that is mounted towards bottom end of the longitudinal members (42a, 42b) is configured and adapted to span across, and be fixedly mounted on them, to hold one to the other.

The other bar (43a) is pivotally mounted on the member (42a) and is configured and adapted to span across to, and be latched or locked onto, the other member (42b). The bars (43a, 43b) each provides a third point of contact for the equipment in the device.

This carrier device is used as described hereinbefore for the device of FIG. 3.

FIGS. 6a and 6b show a side view of a pantograph carrier device assembly, mounted in upright fashion on a wall, respectively at rest, with the jaws closed and in use, with them open. The pantograph carrier device assembly comprises two first jaws (1a, 1b) with two cradles (2a, 2b) for holding equipment, and two second jaws (3a, 3b), movably mounted on the first jaws (1a, 1b) and configured to locate over and span the equipment and urge it into the cradles (2a, 2b).

The carrier device assembly comprises two identical elongate devices, as described hereinbefore in FIGS. 1a, 1b and 1c, and having the same components in addition to the jaws (1, 3) and the cradle (2) and cover (4), such as the second jaws (3a, 3b) each being pivoted to rotate on two pairs of arms that are pivoted on the first jaws (1a, 1b) and the feet (35a, 35b) each projecting inwardly of the bottom ends of the jaws (3a, 3b) of each device.

It will be seen that the feet (35a, 35b) are at opposite ends of the assembly. One serves to support the bottom end of the equipment on the second jaw (3a) and the other as a lid; these form a good protective enclosure during normal storage or transport, and when tilted or inverted in hazardous situations, such as accidents.

The two devices are so arranged that when the arms are in their rest position, those on the lower device (38aa, 38ab and 39aa, 39ab) hang down, and those on the upper device (38ba, 38bb and 39ba, 39bb) extend upwardly, and the jaws (1a, 3a and 1b, 2b) are closed. The devices are connected by a pair of two arms (44a, 45a and 44b, 45b) mutually pivoted to rotate on a pair of pivots (46a, 46b), and also pivoted to rotate on two pairs of pivots (40aa, 40ab and 40ba, 41bb) on each second jaw (3a, 3b). These arms are provided with an outwardly projecting handle (46).

In use of the device assembly, the arms are rotated to a use position outwardly of the first jaws (1a, 1b) by pulling outwardly on the handle (46) at right angles to the assembly. After the equipment has been slid between the first (1a, 1b) and second jaws (3a, 3b) into the cradles (2a, 2b), the second jaws (3a, 3b) of both the devices are rotated to a closure position by ceasing the outward pull on the handle (46). The jaws are configured and adapted to be latched or locked to hold the unladen carrier device assembly in a closure position against gravity by appropriate catch mechanisms (not shown).

Referring to FIG. 7 of the drawings, the carrier device comprises a first jaw (1) with a cradle (2) for holding the equipment, and a second jaw (3), movably mounted on the first jaw (1) and configured to locate over and at least partly span the equipment and urge it into the cradle (2).

The first jaw (1) and its component cradle (2) for the equipment and the second jaw (3) and its optional cover (4) (not shown) are elongate in the same direction, and all of these integers are roughly co-extensive.

The first jaw is provided with a base (11) having an integral cradle (2) formed in the jaw (1) by a shallow V-channel (12), and upstanding flange side walls (13 and 14), the whole defining a rigid first jaw (1). The second jaw (3), which in use cooperates with the cradle (2) to hold an item of equipment, comprises an optional integral cover (4) (not shown) and upstanding flange side walls (33 and 34) and a locating means, here a foot (35), the whole defining a rigid second jaw (3).

The second jaw (3) is provided with two pairs of arms (38a, 38b and 39a, 39b), which are pivoted to rotate on two pairs of pivots (40a, 40b and 41a, 41b) on the second jaw (3), and on two pairs of pivots (20a, 20b and 21a, 21b) on the first jaw (1). One pair of arms (38a, 38b) is mounted towards the top end of the carrier device, and the other (39a, 39b) is mounted towards the bottom end of the carrier device.

The two pairs of arms (38a, 38b and 39a, 39b); all have the same lengths between pivots, so that rotation gives the first (1) and second (3) jaws mutual parallel motion.

The first jaw (1) of the towable or pushable carrier device is provide with a pair of wheels (77a, 77b) mounted on or in the first jaw (1) at or near its base.

When at rest, as in FIG. 1a, the two pairs of arms (38a, 38b and 39a, 39b) hang down, and the jaws are closed.

Referring to FIG. 8 of the drawings, the carrier device comprises a jaw assembly (101), comprising a series of two annular connected members (102, 103), one (102) towards the top end of the carrier structure, the other (103) towards the base.

The members (102, 103) have the same dimensions and configurations.

Each member (102, 103) has a first diametrically aligned lug (104, 105) on its rim on which is mounted a single pivot (106, 107) tangentially aligned to the annulus of the member. Each pivot (106, 107) is adapted to be received and rotate in a trunnion (108, 109) adapted to fixedly mounted on a mounting (110) (not shown).

The part of each annulus by the lug (104 or 105) forms a first jaw (111, 112) and the opposing part a second jaw (113, 114) integral with the first.

The mounting (110) is generally mounted directly or indirectly (e.g. mounted on a board or panel that is directly mounted) on an external structure, here an upright integer, such as a bulkhead, divider, panel, partition, riser, screen or wall.

It may alternatively be mounted on a generally horizontal integer, such as a bottom panel, base plate, floor or stand, or flooring; or the underside of a generally horizontal integer, such as a ceiling, cover, lid, roof or top panel.

Each member (102, 103) has a second diametrically aligned lug (115, 116) on its rim on which is mounted a single pivot (117, 118) tangentially aligned to the annulus of the member.

Each pivot (117, 118) is adapted to be received and rotate in opposing ends of a longitudinal connector (119), here a rigid bar, running generally at right angles to the members (102, 103).

In use, the jaw assembly of the device (101) is rotated to a loading position as shown to receive the equipment. The equipment is then slid into the jaw assembly (101), which is then allowed to return to its rest position hanging downwards under gravity, so that the jaws (111-114) hold the equipment, and the second jaws (113, 114) urge it into the first jaws (111, 112).

Referring to FIG. 9 of the drawings, the carrier device comprises two C-shaped second jaw arms (131, 132), one (131) adapted to be mounted towards the top end of the carrier device, and the other (132) to be mounted towards the bottom end of the carrier device. The two arms (131, 132) have the same dimensions and configurations, and are provided with two pairs of pivots (133a, 133b and 134a, 134b).

Each pivot is adapted to be received and rotate in a trunnion (135a, 135b and 136a, 136b) adapted to fixedly mounted on an external structure, here an upright integer, such as a bulkhead, divider, panel, partition, riser, screen or wall (137) (not shown). The integer (137) forms a first jaw in the device.

It may alternatively be mounted on a generally horizontal integer, such as a bottom panel, base plate, floor or stand, or flooring; or the underside of a generally horizontal integer, such as a ceiling, cover, lid, roof or top panel.

Each second jaw arm (131, 132) has a diametrically aligned lug (138, 139) on its rim on which is mounted a single pivot (140, 141) tangentially aligned to the curve of the second jaw arm (131, 132). Each pivot (140, 141) is adapted to be received and rotate in opposing ends of a longitudinal connector (142), here a rigid bar, running generally at right angles to the jaws (131, 132).

The lower jaw arm (132) encloses a cup (143) for receiving the base of the equipment to be held by the carrier device.

In use, the second jaw arms of the device are rotated to a loading position as shown to receive the equipment. The equipment is then slid into the second jaw arms (131, 132), which are then allowed to return to a rest position hanging downwards under gravity, so that the jaw arms (131, 132) hold the equipment, and the second jaws (131, 132) urge it into the first jaw (137).

Referring to FIG. 10 of the drawings, the carrier device comprises a first jaw (1) with a cradle (2) for holding the equipment, and a second jaw (3), movably mounted on the first jaw (1) and configured to locate over and at least partly span the equipment and urge it into the cradle (2).

The first jaw (1) and its component cradle (2) for the equipment and the second jaw (3) and its component cover (4) are elongate in the same direction, and all of these integers are roughly co-extensive.

The first jaw is provided with a base (11) having an integral cradle (2) formed in the base (11) of the jaw (1) by a shallow V-channel (12), the whole defining a rigid first jaw (1).

The second jaw (3) comprises an integral cover (4), defined by an integral shallow-V projection (31) (not shown) and in use cooperating with the cradle (2) to hold an item of equipment, the whole defining a rigid second jaw (3).

The second jaw (3) is provided with two pairs of arms (38a, 38b and 39a, 39b), which are pivoted to rotate on two pairs of pivots (40a, 40b and 41a, 41b) on the second jaw (3), and on two pairs of pivots (20a, 20b and 21a, 21b) on the first jaw (1). One pair of arms (38a, 38b) is mounted towards the top end of the carrier device, and the other (39a, 39b) is mounted towards the bottom end of the carrier device.

Each arm is a composite arm which consists of two part arms that are pivotally mounted on each other. Thus, the arm (38a) consists of two part arms (138aa, 138ab), which are pivoted to rotate on a pivot (140a) through both part arms. Similarly, the other arms (38b, 39a, 39b) are each a composite arm which consists respectively of two part arms (138ba and 138bb, 139aa and 139ab, and 139ba and 139bb) that are pivotally mounted on each other, respectively at pivots (140b, 141a and 141b) through both respective part arms.

The two arms on each side of the device (respectively (38a and 39a, and 38b and 39b) are connected by a longitudinal connector, here a rigid strip (150a, 150b), which is pivotally mounted on the arms on the mid-point pivot of each arm, and running generally parallel to the first and second jaws and any cradle.

All the part arms in the device have the same lengths between pivots. Similarly, the two connectors are of the same length between pivots. Opposing arms, pivots and longitudinal connectors will be mutual mirror images which are symmetrical about the mid-line of the jaws of the device.

Thus, rotation about the pivots gives the first and second jaws mutual parallel motion which is symmetrical about the mid-point pivot of each arm and the equipment in the device.

A locating means, here a horizontal base (160) projecting inwardly of the bottom end of the jaw(s) of the device to locate one end of the equipment longitudinally between the jaws and to support the bottom end of the equipment is mounted on to extend between and at right angles to the connectors (150a, 150b) at the lower end of the carrier structure.

When such a device is at rest on the base (160), the two pairs of arms (38a, 38b and 39a, 39b) hang roughly level, and the jaws are open. In use of the device, the jaws (1, 3) are lifted (e.g. by means of an optional recessed handhold (170) (not shown so that the arms (38a, 38b and 39a, 39b), rotate about their pivots (40a, 40b and 41a, 41b) on the second jaw (3), on the two pairs of pivots (20a, 20b and 21a, 21b) on the first jaw (1), and on the two pairs of pivots (140a, 140b, 141a and 141b), to give the first (1) and second (3) jaws mutual parallel motion and close them.

1. A device for holding equipment, characterised by
a first jaw with a cradle for holding the equipment, and
a second jaw, movably mounted on the first jaw and configured to locate over and at least partly span the equipment and urge it into the cradle.

2. A device according to claim 1 characterised by at least one locating means on and projecting inwardly from the second jaw, which locates the equipment between the jaws, such that in use of the device, when the equipment presses on the locating means it causes the jaws to close to hold and support the equipment.

3. A device according to claim 1 characterised in that the equipment is elongate, and in use of the device the locating means engages with one end of the equipment, to locate the equipment longitudinally between the jaws, and urging the equipment longitudinally between the jaws against the locating means causes the jaws to close to hold and support the equipment.

4. A device according to claim 1 characterised in that the first jaw and the cradle for holding the equipment are different integers.

5. A device according to claim 1 characterised in that the first jaw is integral with the cradle.

6. A device according to claim 1 characterised in that the first jaw and the cradle are elongate in the same direction.

7. A device according to claim 1 characterised by a second jaw which comprises a movable cover which is pivoted to rotate on at least two pairs of arms that are pivoted on the first jaw and spans the cradle for holding the equipment.

8. A device according to claim 1 characterised in that the second jaw and the cover are different integers.

9. A device according to claim 1 characterised in that the second jaw is integral with the cover.

10. A device according to claim 7 characterised in that one pair of only two pairs of arms is mounted towards one end of the carrier device, and the other is mounted towards an other end of the carrier device.

11. A device according to claim 10 characterised in that the first jaw and the cradle and the second jaw and its cover are elongate in the same direction, and all of these integers are roughly co-extensive.

12. A device according to claim 10 characterised in that the two pairs of arms that are pivoted on the two jaws of the device have the same lengths between pivots.

13. A device according to claim 7 characterised in that the cradle and the cover are elongate in the same direction, and the cradle is formed in the first jaw by a shallow V-channel, and the cover is defined by an integral shallow-V projection.

14. A device according to claim 1 characterised in that one jaw is mounted on a fixed surface, with the mounted jaw running generally along the mounting surface.

15. A device according to claim 12 characterised in that the mounted jaw of the device is mounted upright on an upright integer, such that in use the arms rotate, and the movable jaw urges the equipment into the cradle, under gravity.

16. A device according to claim 1 characterised in that the jaws are urged together by a spring bias.

17. A device according to claim 1 characterised in that in use the jaws are pushed together, and then fastened to hold the equipment in place.

18. A device according to claim 1 characterised in that one or both jaws is/are provided with at least one locating means projecting inwardly of the bottom end of the jaw or jaws to locate one end of the equipment longitudinally between the jaws.

19. A device according to claim 1 characterised in that the second jaw is slidably mounted on the first jaw.

20. A device according to claim 18 characterised in that the second jaw is mounted on one or more retractable arms running generally at right angles to the first jaw, and housed in cooperating sleeves in or on the first jaw.

21. A device according to claim 1 characterised in that it is a towable or pushable structure.

22. A device according to claim 21 characterised in that it is provided with at least one rolling means.

23. A device according to claim 21 characterised in that it is provided with at least two rolling means.

24. A device according to claim 21 characterised in that it is provided with one pair of rolling means.

25. A device according to claim 21 characterised in that it is provided with one pair of rollers or wheels.

26. A device according to claim 12 characterised in that it is a towable or pushable structure.

27. A device according to claim 21 characterised in that it is provided with one pair of rollers or wheels mounted on or in the junction of the first jaw and a locating means projecting inwardly of the first jaw.

28. A device according to claim 21 characterised in that rolling means are installed in a fixed position.

29. A device according to claim 21 characterised in that the rolling means are retractable.

30. A container comprising a device according to claim 1.

31. A container according to claim 30 characterised in that it is a towable or pushable structure.

32. A container according to claim 31 which comprises one pair of rollers or wheels.

33. A towable or pushable structure comprising a container according to claim 30.

34. A structure according to claim 33 characterised in that it comprises one pair of rollers or wheels.
